(19) United States
(12) Patent Application Publication
(10) Pub. No.: US 2025/0244218 A1
(43) Pub. Date: Jul. 31, 2025

(54) AIRCRAFT BATTERY COOLANT DENSITY MONITORING

(71) Applicant: Joby Aero, Inc., Santa Cruz, CA (US)

(72) Inventor: Robert Wilson Rowland, San Francisco, CA (US)

(21) Appl. No.: 19/041,193

(22) Filed: Jan. 30, 2025

Related U.S. Application Data
(60) Provisional application No. 63/721,491, filed on Nov. 16, 2024.
(60) Provisional application No. 63/626,980, filed on Jan. 30, 2024.

(51) Int. Cl. G01N 9/00; B60L 53/16; B60L 53/60; B60L 58/26; B64F 1/35; B64F 1/36

(52) U.S. Cl. CPC G01N 9/00; B60L 58/26; B64F 1/35; B64F 1/362; B60L 53/16; B60L 53/60; B60L 2200/10

(57) ABSTRACT

Examples relate to thermal management systems for electric aircraft charging operations. A thermal conditioning system maintains coolant at controlled temperatures using a pressurized reservoir with an air separation system. A controller determines coolant composition by calculating density based on pressure measurements from a bottom-mounted sensor and volume measurements from multiple sources including float switches and flow sensors. The controller processes the measurements to determine glycol-to-water ratio and validates the calculations using conductivity sensing. The system maintains coolant temperature while regulating reservoir pressure through a pressurized headspace. An air separation system removes entrapped gases to maintain thermal conductivity. The system enables continuous monitoring and control of coolant properties during charging operations to maintain optimal battery pack temperatures.

### CROSS-REFERENCE TO RELATED APPLICATION

This patent application claims the benefit of U.S. Provisional Patent Application No. 63/626,980, filed Jan. 30, 2024, entitled “TEMPERATURE REGULATED COOLANT SYSTEM FOR ELECTRIC VEHICLES” and U.S. Provisional Patent Application No. 63/721,491, filed Nov. 16, 2024, entitled “AIRCRAFT BATTERY COOLANT DENSITY MONITORING DEVICE AND AIRCRAFT BATTERY THERMAL MANAGEMENT USING DUAL PUMPS”, which are incorporated by reference herein in their entireties.

### BACKGROUND

The development of electric aircraft has introduced a new set of challenges and opportunities in the field of aviation. As the industry shifts towards more sustainable and environmentally friendly solutions, electric propulsion systems have become a focal point of innovation. These systems rely heavily on advanced battery technology, which necessitates efficient thermal management to ensure safety, performance, and longevity.

Traditional aircraft have used internal combustion engines that produce a significant amount of heat, which is managed through various cooling systems. However, electric aircraft present a different thermal management paradigm. The batteries used in electric aircraft are sensitive to temperature variations, and their optimal operation, charging, and discharging efficiencies are closely tied to their thermal state. Excessive heat can lead to reduced battery life and potential safety risks, while temperatures that are too low can result in decreased power output and charging rates.

The need for precise thermal management is challenging during the charging process. Rapid charging, in particular, can generate substantial heat within the battery cells, requiring a cooling system that can quickly and effectively dissipate this heat to prevent damage. Conversely, in colder environments, there may be a need to warm the batteries before charging to ensure they are within the optimal temperature range for energy intake.

The advent of electric aircraft has spurred the development of ground support equipment (GSE) that not only facilitates the charging of aircraft batteries but also actively manages their temperature during the process.

As the electric aircraft industry continues to grow, the importance of effective thermal management systems becomes increasingly apparent. Innovations in this area are needed for the advancement of electric aviation and the realization of its potential benefits, including reduced carbon emissions, lower operating costs, and the opening of new possibilities for aircraft design and functionality.

### BRIEF DESCRIPTION OF SEVERAL VIEWS OF THE DRAWINGS

To easily identify the discussion of any particular element or act, the most significant digit or digits in a reference number refer to the figure number in which that element is first introduced.

FIG. 1 is a schematic diagram illustrating ground support equipment (GSE), according to some examples, which may provide charging and other support services to multiple electric-powered aircraft.

FIG. 2 is a flow diagram showing a thermal conditioning circuit within a thermal management system for electric aircraft, according to some examples.

FIG. 3 is a schematic diagram showing a coolant composition monitoring system for an electric aircraft charging station, according to some examples.

FIG. 4 is a flowchart illustrating a method for monitoring and controlling coolant composition in an electric aircraft charging system, according to some examples.

FIG. 5 is a flowchart illustrating a method for controlling coolant volume in an electric aircraft thermal management system, according to some examples.

FIG. 6 is a block diagram showing the interaction between a fluid controller and a thermal conditioning circuit within a ground support equipment system, according to some examples.

FIG. 7 is a conceptual diagram showing various observers and algorithms that contribute to the charging and thermal management of an electric aircraft, according to some examples.

FIG. 8 is a flowchart showing the data processing and mode determination operations within a ground support equipment system for electric aircraft, according to some examples.

FIG. 9 is a schematic diagram showing an electric vehicle charging system, according to some examples.

FIG. 10 is a plan view of an aircraft, according to some examples.

FIG. 11 is a schematic view of an aircraft energy storage system, according to some examples.

FIG. 12 illustrates a diagrammatic representation of a machine in the form of a computer system within which a set of instructions may be executed for causing the machine to perform any one or more of the methodologies discussed herein, according to some examples.

### DETAILED DESCRIPTION

The thermal management system integrates multiple subsystems to regulate coolant temperature and composition during electric aircraft charging operations. A pressurized reservoir system uses an insulated tank (e.g., rated for 0-14 psi operation with a capacity between 1000-800 liters). The system maintains a pressurized headspace to ensure proper pump operation and prevent suction effects on the aircraft coolant system.

The coolant circulation pathway incorporates several components. A centrifugal send pump propels coolant toward the aircraft, while a positive displacement return pump functions as a variable valve to regulate flow. The system employs dry-break couplings for secure connections and includes multiple filtration stages.

Composition monitoring utilizes multiple sensor inputs. A pressure sensor at the reservoir bottom works in conjunction with a float switch to enable density calculations. Flow rate sensors track the differential between send and return lines, while a horizontally-mounted conductivity sensor validates coolant composition. An ion exchange cartridge system maintains coolant purity by removing conductive contaminants.

The control system processes these inputs to maintain operating conditions. It calculates coolant density and composition, regulates pump speeds and flow rates, and maintains pressure and temperature setpoints. The system generates alerts for parameter deviations and can initiate automated responses such as emergency shutdowns when necessary.

An air management subsystem prevents thermal conductivity degradation. It incorporates an air separation disc with support fence and utilizes gravity-based separation to remove entrapped gases. The cable tub design ensures all air flows upward to the charge handle, eliminating air. trap

The thermal management system integrates multiple subsystems to enable control of coolant circulation for electric aircraft battery cooling. A dual-pump configuration comprises a centrifugal send pump propelling coolant at high flow rates while a positive displacement return pump creates variable flow resistance through speed modulation.

The coolant reservoir system maintains fluid conditions through an insulated pressurized tank that stores coolant at controlled temperatures. A pressurized headspace helps maintain pump prime when equipment is positioned below aircraft level, while specialized air separation mechanisms remove trapped bubbles that could reduce thermal conductivity.

Fluid quality management incorporates ion exchange cartridges to remove corrosive ions, conductivity sensors to monitor coolant purity, and multi-stage filtration to protect system components. The control system provides continuous monitoring through flow sensors in the send and return lines, with a volume compensator observer estimating fluid volumes when direct measurement becomes unavailable.

For below-ground installations, the system actively cools electronics enclosures using the cold coolant supply and employs pressurized reservoir systems to maintain pump prime. Safety features include recirculation valves to prevent coolant spillage if cooling plates become blocked, pressure relief systems to protect against over-pressure conditions, and filtration systems to prevent damage to precision components.

The thermal conditioning circuit enables rapid battery charging while maintaining safe temperatures through precise control of coolant volumes and flow rates. The architecture allows integration with aircraft thermal management systems and adaptation to different charging station configurations while maintaining consistent performance across operating conditions.

Control mechanisms provide real-time adjustment of pump speeds based on multiple sensor inputs, coordinating various subsystem operations while maintaining backup operational modes when primary sensors become unavailable. The system addresses technical challenges including maintenance of precise coolant volumes, prevention of air ingress, protection of components from contamination, and enabling of rapid charging while maintaining safe operating temperatures.

### Ground Support Equipment (GSE) for Electric-Powered Aircraft

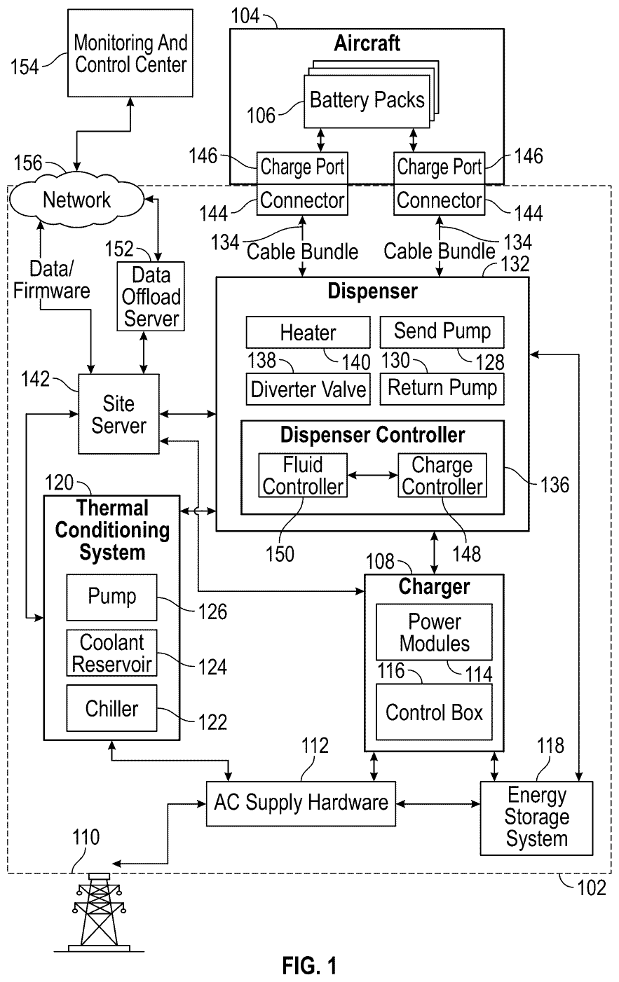

FIG. 1 is a schematic diagram that illustrates a GSE 102, according to some examples, which is designed to provide charging and other support services to multiple electric-powered aircraft 104. The example GSE 102 enables the rapid charging of the battery packs 106 of the electric aircraft 104, thereby enhancing the efficiency and operational readiness of the aircraft.

The GSE 102 comprises several components that contribute to efficient charging and support services. A charger 108 receives electrical charge from a power supply network 110, via AC supply hardware 112, and distributes it to charge the battery packs 106 of the aircraft 104. The charger 108 is designed with a modular architecture that can be configured for different aircraft battery configurations, thereby providing flexibility and adaptability in its operation.

The charger 108 includes multiple power modules 114 that allow for the independent charging of each of the multiple isolated and redundant battery packs 106 in the aircraft 104. This independent charging capability ensures that each battery pack 106 receives the appropriate amount of charge based on its specific requirements.

A control box 116 serves as the central coordinating unit for the power modules 114, orchestrating their operation so that the charging process is conducted in a safe and effective manner. The control box 116 is designed to manage the interplay of electrical currents, voltages, and temperatures that occur during the charging process, ensuring that each of the power modules 114 operates within its specified parameters. By coordinating the operation of the power modules 114, the control box 116 ensures that each battery pack 106 receives the appropriate amount of charge based on its specific requirements. The control box 116 continuously monitors the status of each of the power modules 114, adjusting their operation as and when deemed beneficial. Furthermore, the control box 116 also plays a role in the safety of the charging process. It is equipped with safety features that monitor the operation of the power modules 114 for anomalies or potential issues. If any such issues are detected, the control box 116 can take action to mitigate the risk, such as by adjusting the operation of the affected power battery module 1102 (FIG. 11) or even shutting battery modules 1102 down if deemed to be beneficial.

The GSE 102 also incorporates a ground-based energy storage system 118. This energy storage system 118 is connected to the power supply network 110, enabling it to receive electrical power efficiently. The connection to the power supply network 110 is facilitated via the AC supply hardware 112, which enables the transfer of electrical charge from the power supply network 110 to the energy storage system 118.

The ground-based energy storage system 118 serves as a backup power source, storing electrical energy that can be used to charge the aircraft's battery packs 106 when the power supply network 110 is unavailable or insufficient. Furthermore, the ground-based energy storage system 118 can also contribute to the overall efficiency of the GSE 102. By storing electrical energy during off-peak hours when electricity rates are lower, and then using this stored energy to charge the aircraft's battery packs 106 during peak hours, the ground-based energy storage system 118 can help to reduce the overall energy costs of the GSE 102.

Another component of the GSE 102 is the thermal conditioning system 120. This system maintains the health and longevity of the battery packs 106 by thermally conditioning them during the charging process. The thermal conditioning system 120 is designed to manage the heat generated by the battery packs 106 during charging so that they remain within the operating temperature range. This is achieved through a cooling process that involves the use of a chiller 122 and a coolant fluid. The thermal conditioning system 120 may provide sufficient cooling capacity to cool battery packs, particularly towards the end of a charging cycle. The cooling of the packs towards the end of the cycle may be helpful for vehicles that do not have active onboard cooling, to ensure that the battery packs are at an optimal or desired temperature before departure from the GSE 102.

The chiller 122 operates to chill the coolant fluid to a specific temperature. This chilled coolant fluid is then stored in a coolant reservoir 124, ready to be circulated through the battery packs 106 during the charging process. The chiller 122 is capable of rapidly chilling the coolant fluid, ensuring that it is ready to be circulated through the battery packs 106 at a moment's notice.

The circulation of the coolant fluid is facilitated by pumps 126 of the thermal conditioning system 120, as well as a send pump 128 and a return pump 130 of one or more dispensers 132. The pumps 126 draw the chilled coolant fluid from the coolant reservoir 124 and circulate it to the dispensers 132 and then through hoses that form part of cable bundles 134. Each cable bundle 134 is a network of hoses and cables that connect the various components of the GSE 102, and is designed to facilitate the transfer of coolant fluid, electrical charge, and data between the GSE 102 and the aircraft 104.

Each dispenser 132 has multiple components including a dispenser controller 136 (e.g., embodied as a main logic board), a send pump 128, a return pump 130, a diverter valve 138, and a heater 140, as well as a number of filters. These components are described in further detail below. Dispensers 132 are also coupled to a site server 142 that regulates the power and coolant flow to one or more aircraft 104. A single site server 142 may operate with the dispenser controllers 136 of a single or multiple dispensers 132.

The coolant fluid is circulated from a dispenser 132 to an internal cooling system of an aircraft 104 via connectors 144, which may include charge handles. These connectors 144 facilitate the transfer of coolant fluid between the GSE 102 and the aircraft 104. They form a shared coolant loop that enables fast battery cooling during charging. For example, the connectors 144 connect to the aircraft's charge ports 146 to facilitate the exchange of data, charge, and coolant between the GSE 102 and the aircraft 104. A cable bundle 134 routes the power, coolant, and data connections from the charger 108, chiller 122, and coolant reservoir 124 to the dispensers 132 and, ultimately, to the connectors 144. The dispensers 132 may also be equipped with docks specifically designed to accommodate the connectors 144 and stow the connectors 144 when not in active use.

A dispenser controller 136, which may be housed within the dispenser 132, is responsible for thermal management and charging process at an individual system level. It orchestrates the operation of one or more dispensers 132. As noted above, each dispenser 132 may be equipped with a send pump 128 that actively sends coolant to the aircraft 104, complemented by another return pump 130 that extracts the coolant, thereby maintaining a regulated flow for optimal thermal management during the charging cycle. Each dispenser controller 136 includes a fluid controller 150 (which controls a thermal conditioning circuit for thermal management) and a charge controller 148 (which controls charging). The fluid controller 150 operates in unison with the charge controller 148 to achieve optimal charging. Fluid control and charge control are tightly coupled. Consider an example situation in which an aircraft that has been sitting overnight in cold temperatures, as a result its batteries are currently 9?C. Upon connection of the GSE 102, the batteries will first be heated up to 40?C for efficient charging. Then the charging current is ramped up by the charge controller 148, and the fluid controller 150 pumps a small amount of cold coolant to hold the batteries at a steady 40?C temperature. Once the batteries are nearly fully charged, the charge current is tapered off by the charge controller 148, while the fluid controller 150 ramps up the flow of cold coolant to bring the batteries down to the optimal temperature for the next flight mission (usually near 20?C).

A site server 142 monitors and controls certain components of the GSE 102. The site server 142 operates with the dispenser controllers 136 to ensure the exchange of data, charge, and coolant to the aircraft 104 while maintaining safe operating temperatures and conditions. The site server 142 and dispenser controllers 136 also control thermal conditioning and charging processes based on feedback from the battery packs 106, optimizing the charging for each specific aircraft. The site server 142 is also tasked with managing power distribution and scheduling across various chargers, ensuring efficient use of resources and adherence to charging timetables. It may operate as a central hub that coordinates the activities of individual chargers, taking into account inputs from the aircraft 104, the dispensers 132, and broader operational requirements.

A data offload server 152 collects and manages data related to the charging operations. This data includes telemetry data from the aircraft 104, status data from GSE 102 components like the thermal conditioning system 120, and information on the charging sessions. The data offload server 152 stores and aggregates the data it collects from the various subsystems of the GSE 102 and the aircraft 104. It can offload or transfer the charging operations data to other systems for purposes such as monitoring, analytics, scheduling, and other applications. This feature enhances the overall management and oversight of the charging operations, contributing to the efficient operation of the GSE 102.

The GSE 102 may be linked to a monitoring and control center 154 via a network 156. The monitoring and control center 154 is equipped with monitoring capabilities that allow it to track the status of various operations and components of the GSE 102 in real time.

By continuously monitoring the charging process and making appropriate adjustments, the monitoring and control center 154 ensures that the battery packs 106 are charged in a manner that maximizes their performance and longevity. This not only enhances the operational readiness of the aircraft but also contributes to the overall lifespan of the battery packs 106, thereby reducing maintenance costs and downtime. Furthermore, the monitoring and control center 154 also plays a role in ensuring the safety of the charging operations.

### Thermal Conditioning Circuit 200

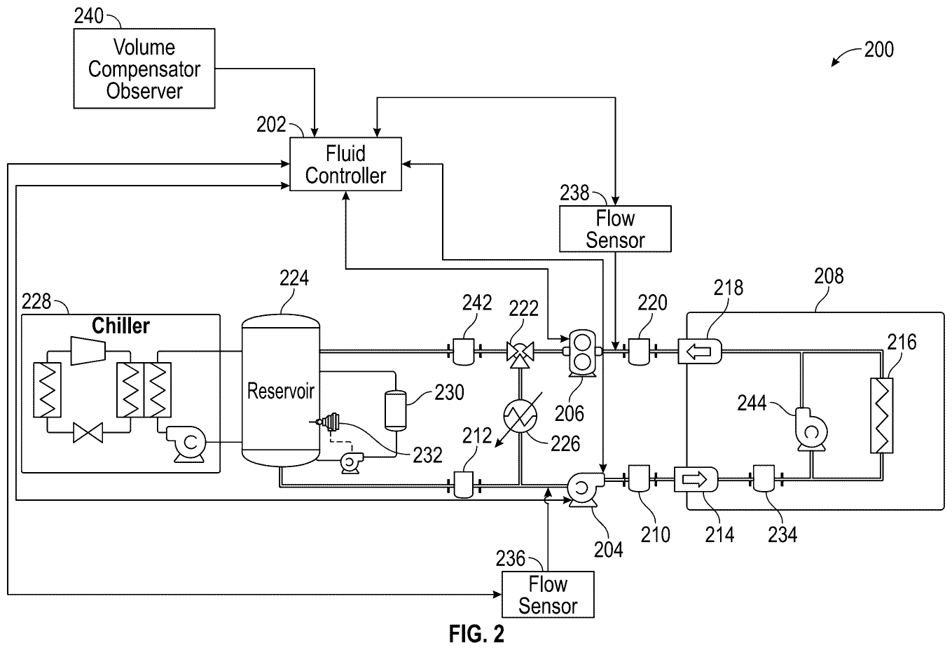

FIG. 2 is a flow diagram illustrating a coolant flow path in the form of a thermal conditioning circuit 200 of the GSE 102, according to some examples. The diagram provides a detailed view of the components involved in circulating and conditioning the coolant used to manage the temperature of the battery packs during the charging process.

The thermal conditioning circuit 200 includes two pumps, a send pump 204 and a return pump 206, which are responsible for circulating the coolant through the thermal conditioning circuit 200. The send pump 204, for example a centrifugal pump, propels the coolant towards a vehicle 208, while the return pump 206, for example, a positive coarse displacement pump, draws the coolant away from the vehicle 208, ensuring a continuous flow.

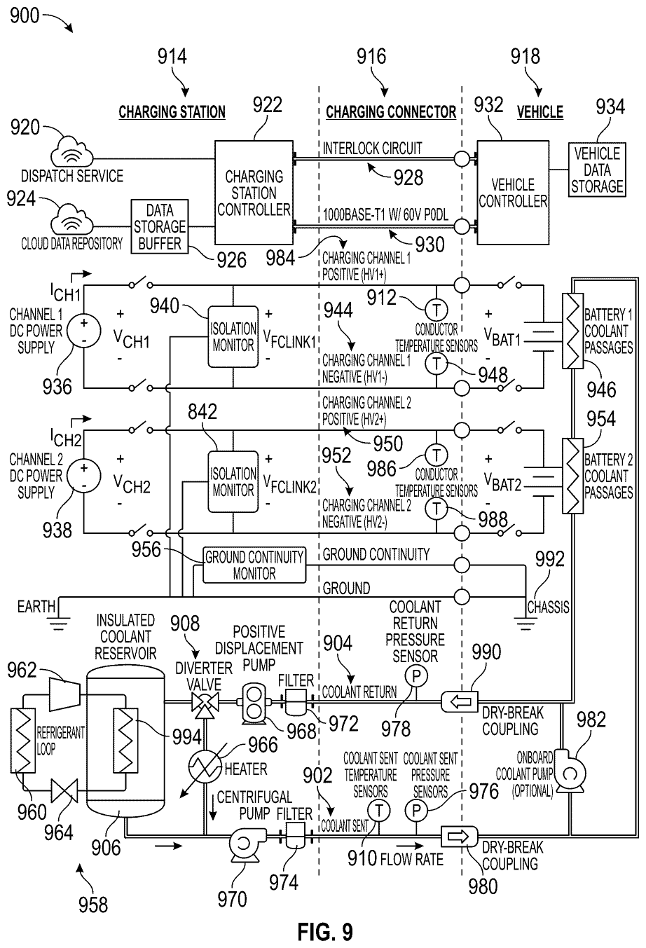

Before the coolant is propelled by the send pump 204 through a cable bundle 134 including coolant send conduits 902 and coolant return conduits 904 (shown in FIG. 9), it is pushed through a series of filters to remove particulate matter. A send coarse particulate filter 210 captures larger particles, while a send fine particulate filter 212 removes finer debris, ensuring the cleanliness of the coolant before it enters the aircraft's systems.

The coolant exits a coolant send conduit of the cable bundle 134 and then flows through a send dry-break coupling 214 of a connector 144, which provides a secure connection to the vehicle 208, allowing for the safe transfer of coolant into the battery coolant passages 216. This connection maintains the integrity of the thermal conditioning circuit 200 and prevents contamination or spillage of the coolant.

The coolant is circulated through battery coolant passages 216 of the vehicle 208 (aided by an onboard coolant pump 244) and, having absorbed heat from the battery packs of the vehicle 208, exits the vehicle 208 through another return dry-break coupling 218 of the connector 144 and enters the return side of the thermal conditioning circuit 200. Here, it passes through a return coarse particulate filter 220, which further cleanses the coolant of any impurities picked up during its passage through the vehicle 208.

A diverter valve 222 operatively directs the flow of coolant either back to the coolant reservoir 224 for cooling or through a heater 226 for heating, depending on the thermal requirements of the aircraft. The operation is controlled by a temperature control or adjuster mechanism, in the example form of a fluid controller 202, which allows for precise control of the coolant temperature by mixing flows from the chiller 228 and the heater 226. The diverter valve 222 may be a ball valve, a butterfly valve, a three-way valve, or a rotary valve, for example.

The heater 226, equipped with a heating element, can rapidly increase the temperature of the coolant when necessary. This feature may be particularly useful during colder conditions or when the batteries require pre-heating before charging to reach optimal temperatures (e.g., as indicated by the thermal observer outputs described below).

In some examples, the send pump 204, return pump 206, diverter valve 222, heater 226, send coarse particulate filter 210, and return coarse particulate filter 220 are contained within a dispenser 132, such as that described above with reference to FIG. 1

The chiller 228 maintains coolant stored in the coolant reservoir 224 at a low temperature, for example around −10° C. The chiller 228 ensures that the coolant is sufficiently cold to absorb the heat generated by the battery packs during the charging process. The coolant reservoir 224, which stores the chilled coolant, is designed to hold a large volume of coolant to support continuous operation of the thermal conditioning circuit 200 and to accommodate the thermal load during peak charging periods. In some examples, the coolant reservoir 224 provides additional cooling capacity for fast cooling of the battery packs at the end of a charging session, for example just before the vehicle 208 departs and accelerates (e.g., an electric aircraft takes off, during which rapid battery pack heating may occur).

A return fine particulate filter 242 filters fine grain particulates from coolant flow channeled by the diverter valve 222 to the coolant reservoir 224, from where coolant is circulated by a pump through a chiller 122.

An ion exchange cartridge 230 and a conductivity sensor 232 work together to maintain the chemical quality of the coolant. The ion exchange cartridge 230 removes unwanted ions that could lead to corrosion or scaling within the system, while the conductivity sensor 232 monitors the electrical conductivity of the coolant, providing an indication of its purity and chemical composition.

The ion exchange cartridge 230 may operate in a dedicated deionization loop that circulates to continuously filter the coolant. The ion exchange cartridge 230 may be installed vertically and incorporates non-ionic inhibitors that create a passive layer on metal surfaces to prevent corrosion and ion leaching. This passive layer protection extends to multiple metal types including stainless steel and titanium components within the thermal conditioning circuit 200.

The conductivity sensor 232, for example positioned horizontally to a pipe leading into the coolant reservoir 224, provides continuous monitoring of the coolant's electrical properties. The conductivity sensor 232 may detect changes in conductivity that may indicate contamination or degradation of the coolant mixture. In some examples, the conductivity measurements remain below a threshold (e.g., 5 S/cm) when the system is operating properly. The conductivity sensor 232 works in conjunction with the deionization loop, which activates when conductivity measurements exceed specified thresholds.

A coolant quality monitoring system, including some of the components mentioned above, may implement certain features to maintain proper operation:
The deionization loop may operate air traps.
Service valves may be positioned on both sides of the ion exchange cartridge 230 for maintenance access
A drain valve allows servicing of the deionization loop

The coolant quality monitoring system integrates with the broader thermal conditioning circuit 200 through:
Continuous circulation through the deionization loop during system operation
Real-time conductivity monitoring for early detection of contamination
Automated control of the deionization process based on sensor feedback.
Integration with the fluid controller 202 for system monitoring and control

The diagram also includes a filter 234, which may represent an additional stage of filtration or a specific type of filter designed for a particular purpose, such as removing dissolved gases or organic contaminants from the coolant.

### Positive Displacement Return Pump 206

As noted above, the thermal conditioning circuit 200 may enable precise coolant volume control in electric aircraft applications. The coolant reservoir 224 stores and maintains the coolant mixture at specified temperatures. The coolant reservoir 224 incorporates a pressure sensor at its base and a level sensor to measure coolant height, enabling a controller to calculate coolant density and monitor the glycol-to-water ratio.

As also noted above, the thermal conditioning circuit 200 employs one or more pumps working in coordination. In some examples, the send pump 204 is a centrifugal pump that operates as the primary flow generator, capable of running at high flow rates to rapidly deliver coolant to the vehicle 208. In some examples, the return pump 206 is a positive displacement pump, implemented as a gear pump in some examples, which creates precise variable flow resistance in the return path. This dual-pump configuration may enable faster and more precise volume control compared to traditional mechanical valve systems.

An example positive displacement return pump 206 may have specific protection measures due to its gear-based design. A filtration system, including filter 234, removes particulates that could damage the pump's internal components. The gear pump configuration may provide a faster volume control response compared to mechanical valves while maintaining precise flow regulation.

A fluid controller 202 manages the coordinated operation of both pumps. The fluid controller 202 receives input from multiple sensors, including flow sensors (e.g., send line flow sensor 236 and return line flow sensor 238) positioned in both the send and return lines. These sensors provide real-time flow rate data that allows the fluid controller 202 to determine volume changes based on the difference between send and return flow rates.

The flow sensors 236 and 238 may continuously monitor the coolant movement through both the send and return lines, providing real-time data to the fluid controller 202. This data enables accurate tracking of volume changes and allows the fluid controller 202 to make rapid adjustments to maintain desired coolant volumes. The thermal conditioning circuit 200 can transition between different operating modes based on thermal requirements while maintaining precise volume control throughout the charging process.

The flow sensors 236 and 238 in the thermal conditioning circuit 200 may implement electromagnetic flow meter technology. The flow sensors 236 and 238 may provide multiple data inputs to the fluid controller 202, including for example:
Real-time volumetric flow rates in both send and return lines
Differential flow measurements between send and return paths
Data for calculating instantaneous volume changes within the thermal conditioning circuit 200
Input for the volume compensator observer 240 calculations

The flow sensors 236 and 238 work in conjunction with other monitoring devices, including for example:
Pressure sensors at multiple points in the thermal conditioning circuit 200 to verify proper flow conditions
Temperature sensors that enable compensation for thermal effects on flow measurements
Level sensors in the coolant reservoir 224 that help correlate flow data with actual system volumes

The fluid controller 202 may process this flow sensor data to:
Calculate real-time volume changes in the aircraft cooling system
Determine appropriate pump speed adjustments
Monitor for flow anomalies that might indicate system issues
Provide data to the volume compensator observer 240 when direct volume measurements are unavailable

This flow sensors 236 and 238 may further include redundant measurement capabilities, allowing the fluid controller 202 to maintain accurate volume tracking even if one sensor experiences issues.

A volume compensator observer 240 supplements the direct measurements by providing estimated coolant volume data when direct measurement becomes unavailable. This volume compensator observer 240 monitors coolant volume changes and maintains system operation even during sensor interruptions.

The fluid controller 202 operates the centrifugal send pump 204 at high flow rates while adjusting the speed of the positive displacement return pump to regulate coolant volume. This coordinated control enables rapid filling of the aircraft's cooling system while maintaining precise volume management.

The positive displacement return pump 206, in some examples, functions by generating a controlled orifice resistance. This mechanism allows for the manipulation of flow rates and pressures within the system with precision. Unlike systems that rely on mechanical valves to regulate fluid dynamics, this example pump achieves adjustments through speed control. By altering the rotational velocity of its components, the positive displacement return pump 206 can swiftly adapt to varying operational demands without necessitating physical modifications or maintenance interventions associated with moving parts. This offers a more efficient and reliable solution for systems requiring fine-tuned flow management.

### Density-Based Glycol Ratio Detection

A density-based glycol ratio detection system provides a method for determining coolant composition through precise measurements and calculations. The system may use a pressure sensor positioned at the bottom of an insulated pressurized coolant tank, which measures the static pressure of the fluid column.

Volume measurement occurs through one or more methods. A float switch positioned at the 50% fill level may provide discrete measurements, while flow rate sensors on the send and return lines track volume changes. A sight glass enables visual confirmation of fluid levels.

In some examples, a volume compensator with a string potentiometer measures fluid displacement through a bellows device for continuous monitoring.

The control system processes these measurements to determine coolant density. The calculation divides the measured pressure by the product of gravitational acceleration and the measured fluid column height, while accounting for the 25-29 kPa pressurized headspace above the fluid, for example. This density value serves as the basis for determining the glycol-to-water ratio through established fluid property correlations.

The system validates the calculated composition through conductivity measurements. A horizontally-mounted conductivity sensor monitors the electrical properties of the coolant mixture, with proper operation indicated by measurements below 5 μS/cm, for example.

An ion exchange cartridge system works in conjunction with the conductivity sensor to maintain coolant purity and provide additional validation of the composition calculations.

The monitoring system operates continuously during charging operations, providing real-time data on coolant composition. The control system compares the calculated ratios against predetermined ranges and can initiate responses such as alerts, pump speed adjustments, or emergency shutdowns if deviations occur.

This approach enables precise monitoring of a predetermined (e.g., 40% glycol) mixture that optimizes thermal performance while maintaining safe operating conditions.

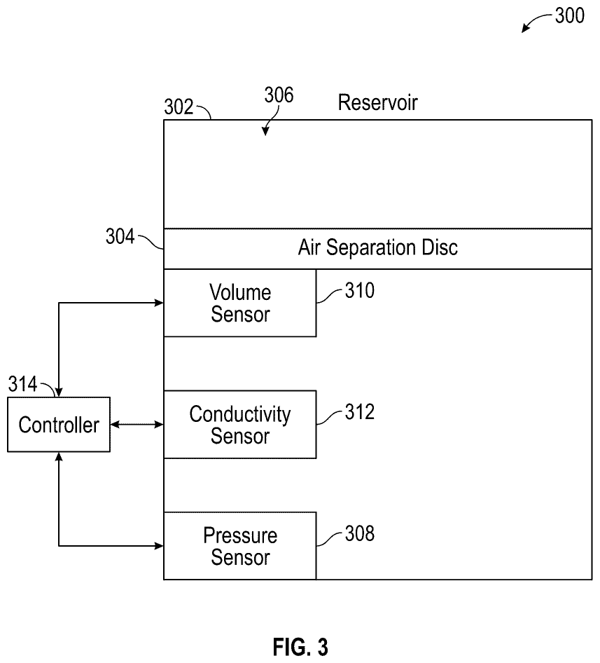

FIG. 3 is a schematic diagram showing a coolant composition monitoring system 300 for an electric aircraft charging station, according to some examples.

The coolant composition monitoring system 300 includes a reservoir (e.g., the reservoir 302) containing a coolant mixture of glycol and water, for example, maintained at a ratio of approximately 40% glycol to optimize thermal performance.

The reservoir 906 incorporates a pressurized headspace 306 maintained between 25-29 kPa and an air separation system to remove entrapped gases from the coolant mixture.

The headspace pressure provides the motive force required to prime the pumps and maintain consistent fluid flow through the coolant composition monitoring system 300. An air release valve positioned above a primary fill line allows controlled venting of accumulated gases while maintaining system pressure.

The air separation system utilizes multiple integrated components working in concert. A specialized air separator actively removes dissolved gases from the circulating coolant through buoyancy and gravity effects. An air separator support fence (e.g., air separation disc 304) provides structural stability for the separation components. Multiple mesh screens, for example rated at 1200 micron, prevent particulate contamination of the separation system while allowing gas permeation.

The pressure control system may maintain precise headspace pressure through several coordinated elements. A pressure relief valve, for example rated for 0-14 psi operation, prevents over-pressurization of the system. An analog pressure gauge enables local monitoring of system pressure, while an electronic pressure sensor provides continuous monitoring and data logging capabilities. An air-fill port valve allows for pressure adjustment and system maintenance.

The air separation components operate through specific physical mechanisms. The system utilizes a perforated baffle plate to distribute coolant flow evenly across the separation chamber.

As the coolant passes through the separation zone, dissolved gases coalesce into bubbles that rise due to buoyancy effects. The rising bubbles collect in designated accumulation zones before being vented through an air release valve.

The pressure management system incorporates additional monitoring capabilities. Pressure sensors positioned at strategic points throughout the circulation path provide real-time data on system performance. The control system processes this pressure data to maintain headspace conditions and detect potential issues such as pump cavitation or flow restrictions. Temperature sensors work in conjunction with the pressure monitoring system to account for thermal effects on fluid properties and gas solubility.

The air separation system addresses specific operational requirements. In some examples, the design accommodates flow rates up to 350 L/min through the chiller circuit and 90 L/min to the dispensers while maintaining effective gas removal.

The system manages air introduction from fluid connectors, which can for example add approximately 1 cc of air per connection cycle. The elevated position of separation components ensures air flows upward to the charge handle, eliminating potential air traps in the fluid circulation path.

The pressure control fluid circulation system 1112 (FIG. 11) accommodates thermal expansion and contraction while maintaining target pressure through specific design features. The reservoir 906 may provide a total flood volume exceeding 700 L, with a target capacity of 800 L, for example.

A controller 314 (which may be the fluid controller 202 or part of the site server 142) obtains real-time data through multiple sensors. A pressure sensor 308 positioned at the bottom portion of the reservoir 906 measures coolant pressure. Volume measurements are obtained through one or more methods and volume sensors 310, such as level sensors, flow rate sensors, or a volume compensator.

The controller 314 processes measurement data to determine coolant composition through fluid property calculations. The controller 314 analyzes the relationship between pressure, volume, and density to monitor the coolant mixture state.

In more specific examples, the controller 314 executes a density determination algorithm that uses pressure readings from the bottom-mounted pressure sensor 308 and volume measurements from one or more volume sensor 310. The controller 314 applies fluid mechanics principles to calculate density by dividing the measured pressure by the product of gravitational acceleration and the measured fluid column height. This calculated density value serves as the basis for determining the glycol-to-water ratio.

In even more specific examples, the controller 314 implements:
A pressure compensation algorithm that accounts for the (e.g., 25-29 kPa) pressurized headspace when calculating the true hydrostatic pressure of the fluid column
A volume tracking system that combines data from float switches positioned at discrete fill levels with continuous flow rate monitoring between the send and return lines
A trend analysis function that stores historical density measurements in a database and applies statistical methods to identify gradual changes in composition over time
A predictive algorithm that analyzes the rate of composition change to forecast when the coolant mixture may require adjustment or replacement
A validation routine that cross-references the density-based composition calculation against conductivity measurements to ensure accuracy.

The controller 314 evaluates coolant composition against established operational parameters and initiates appropriate system responses.

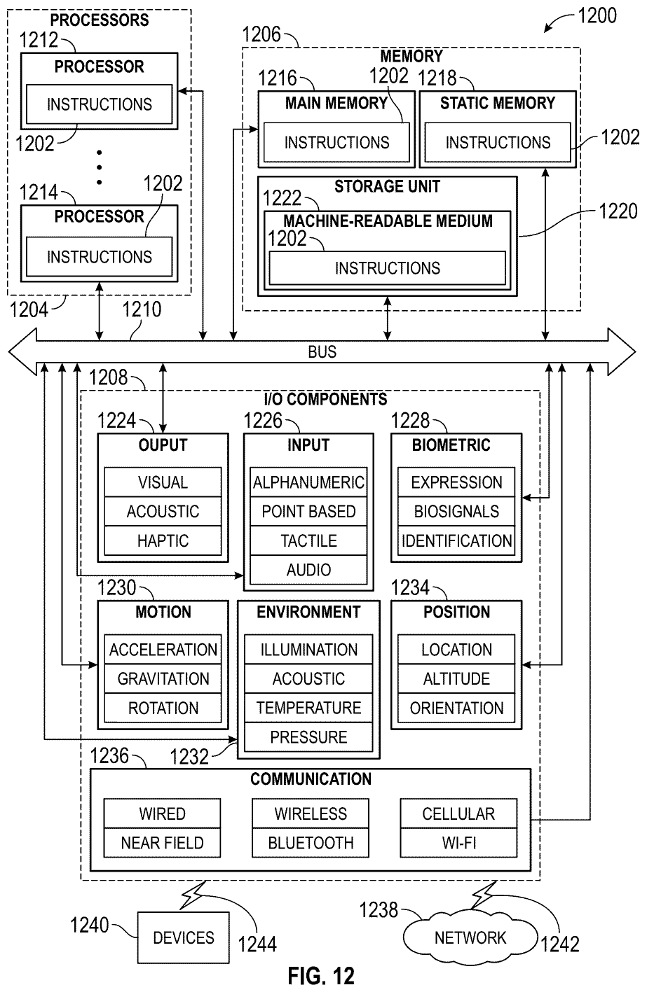

The controller 314 may perform continuous comparison of the calculated glycol-water ratio against predetermined acceptable ranges. When deviations are detected, the system generates alerts through the communication components 1236 (FIG. 12) and may initiate automated response protocols.

In even more specific examples, the controller 314 executes:
An emergency shutdown sequence if coolant composition deviates beyond thresholds, including deactivation of charging circuits and isolation of coolant flow
Adjustment of pump speeds and valve positions to regulate coolant flow rates based on composition readings.
Activation of the air separation system to remove excess entrapped gases that may affect coolant composition
Modulation of the thermal conditioning system 120 to maintain optimal coolant temperature based on the measured composition
Logging of composition data and system responses in the data storage buffer for maintenance analysis
Coordination with the dispenser controller 136 to adjust charging parameters based on coolant conditions
Activation of backup systems or redundant cooling circuits if primary systems are compromised
Initiation of automated purge and refill sequences when coolant composition cannot be maintained within specifications

A conductivity sensor 312 functions as part of the validation system that verifies the accuracy of coolant composition calculations determined through density measurements.

In more specific examples, the conductivity sensor 312 monitors the electrical conductivity of the coolant mixture to detect changes that may indicate contamination or degradation. The conductivity sensor 312 interfaces with the controller 314 to provide real-time measurements that are compared against expected conductivity values for the specified glycol-water ratio.

In even more specific examples, the conductivity sensor 312 implements:
Continuous monitoring of coolant conductivity with measurements below 5 μS/cm for proper operation
Integration with an ion exchange cartridge system that maintains coolant purity by removing conductive contaminants
Detection of sudden conductivity changes that may indicate corrosive debris entering from metal piping
Cross-referencing of conductivity readings with density-based composition calculations to validate mixture ratios.
Communication with the controller 314 to trigger alerts or system responses when conductivity exceeds specified thresholds

A temperature control system (e.g., the thermal conditioning system 120) maintains the coolant mixture at approximately −10° C.

The coolant composition monitoring system 300 incorporates insulation to minimize heat transfer between the coolant mixture and the surrounding environment. A filtration system includes combinations of coarse particulate filters, fine particulate filters, and ion exchange cartridges to maintain coolant purity.

The thermal management system regulates coolant temperature based on the calculated composition. The coolant composition monitoring system 300 operates continuously during charging station operation to ensure consistent monitoring of coolant parameters.

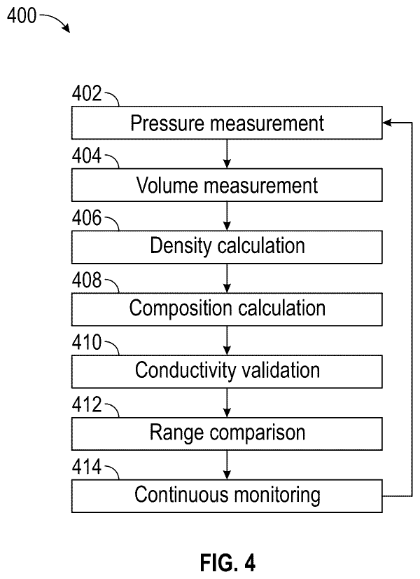

FIG. 4 is a flowchart illustrating a method 400 for monitoring and controlling coolant composition in an electric aircraft charging system, according to some examples.

Although the example method depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

At block 402, a pressure sensor 308 positioned at the bottom portion of the reservoir 906 measures the static pressure of the coolant mixture.

The pressure measurement may account for a predetermined (e.g., the 25-29 kPa) pressurized headspace maintained above a coolant in the reservoir 302.

At block 404, the coolant composition monitoring system 300 measures the volume of coolant mixture using multiple complementary methods. In some examples, aa float switch monitors discrete fluid levels, while flow rate sensors track the differential between send and return flows.

In some examples, a volume compensator with position sensing provides continuous volume monitoring through a bellows device.

At block 406, the controller 314 determines coolant density by processing the pressure and volume measurements. The calculation divides the measured pressure by the product of gravitational acceleration and fluid column height.

At block 408, the controller 314 calculates the glycol-to-water ratio using the determined density value and established density-composition correlations.

At block 410, the coolant composition monitoring system 300 validates the calculated composition through conductivity measurements. A conductivity sensor 312 monitors the electrical conductivity of the coolant, with proper operation indicated by measurements below a determined value (e.g., 5 μS/cm).

At block 412, the controller 314 compares the calculated and validated composition against predetermined acceptable ranges.

If deviations are detected, the controller 314 may:
Generate alerts through the communication system
Adjust pump speeds and valve positions
Activate the air separation system to remove entrapped gases
Modify thermal conditioning parameters to maintain −10° C. coolant temperature
Initiate emergency shutdown procedures if necessary

At block 414, the coolant composition monitoring system 300 maintains continuous monitoring during charging operations through:
Real-time pressure and volume measurements
Active air separation using the separation disc and support fence
Pressure regulation of the headspace between 25-29 kPa
Temperature control at approximately −10° C.

### Positive Displacement Return Pump 206—Operation

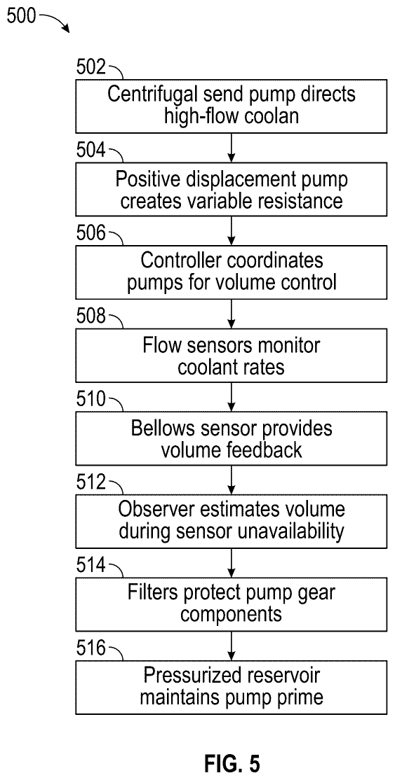

FIG. 5 is a flowchart illustrating a method 500 for controlling coolant volume in an electric aircraft thermal management system, according to some examples, of coordinating pump operations to achieve rapid volume control.

Although the example method depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

At block 502, the fluid controller 202 initiates operation of a centrifugal send pump 204 to direct coolant toward the aircraft 104 at a relatively high flow rate. The centrifugal send pump 204 propels coolant from the coolant reservoir 224 through send conduits to the aircraft's battery coolant passages.

At block 504, the fluid controller 202 operates the positive displacement return pump 206 to create variable flow resistance in the return path. In some examples, the fluid controller 202 adjusts the speed of the gear-type positive displacement pump to effectively create a small, controlled orifice resistance.

In some examples, the positive displacement return pump 206 uses gear pump technology to provide precise flow control through speed modulation. The pump's gear mechanism creates resistance proportional to its operating speed, allowing for rapid adjustments to flow restriction. The fluid controller 202 can modify the effective orifice size by varying the pump speed, providing faster response compared to mechanical valve actuation. The gear pump requires specific filtration through the filter 234 to protect its precision components while maintaining accurate flow control characteristics.

At block 506, the fluid controller 202 coordinates operation of both pumps to achieve rapid volume control. The fluid controller 202 processes inputs from multiple sensors to determine appropriate pump speeds.

In some examples, the fluid controller 202 implements control algorithms that process real-time data from multiple sensor inputs. The fluid controller 202 monitors flow rates, pressures, and temperatures to optimize the coordination between the centrifugal send pump 204 and positive displacement return pump 206. In some examples, the fluid controller 202 adjusts pump speeds based on calculated coolant density and measured flow characteristics. The coordinated control enables rapid volume changes while maintaining system stability.

At block 508, flow sensors positioned in the send and return lines monitor coolant flow rates. The fluid controller 202 calculates volume changes based on the difference between send and return flow measurements. The flow sensors provide continuous measurement of coolant movement through both the supply and return paths. The fluid controller 202 processes this flow rate data to determine instantaneous volume changes within the system. In some examples, the flow measurements also contribute to the volume compensator observer calculations when direct volume sensing is interrupted.

At block 510, a bellows position sensor on the aircraft provides volume-related feedback through a string potentiometer signal. The fluid controller 202 adjusts pump speeds based on this direct volume measurement. The string potentiometer may monitor the position of an expansion/contraction bellows device within the aircraft's thermal system. This direct measurement provides real-time feedback about actual coolant volumes present in the aircraft 104. The fluid controller 202 uses this position data to verify volume calculations and adjust pump operation accordingly.

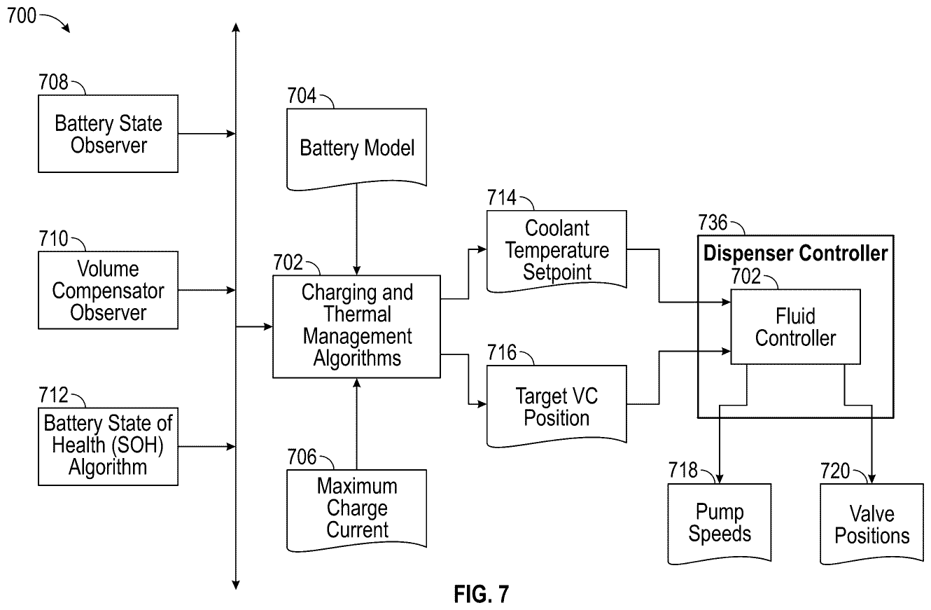

At block 512, if the bellows sensor signal becomes unavailable for example, a volume compensator observer 710 (FIG. 7) estimates current coolant volume using a model that incorporates flow rate differences. This observer maintains volume control during sensor interruptions.

The volume compensator observer 710 uses a mathematical model of the system to estimate coolant volumes when direct measurement is unavailable. The volume compensator observer 710 processes flow rate differences between send and return lines to track volume changes. The model accounts for system characteristics and operating conditions to maintain accurate volume estimation during temporary sensor signal losses. This redundant monitoring capability allows the fluid controller 202 to maintain coordinated pump control even when primary sensors are interrupted.

At block 514, filters remove particulates from the coolant before it enters the positive displacement return pump 206. The filtration protects the pump's internal gear components from damage that could affect volume control precision.

At block 516, for installations where the pumps are positioned below the aircraft, the system pressurizes the reservoir headspace to maintain pump prime. This prevents pump cavitation and ensures consistent coolant flow.

The fluid controller 202 continuously monitors these operations and adjusts pump speeds to maintain precise volume control throughout the charging process. The controller 202 may transition between different operating modes based on sensor feedback and system conditions.

### Fluid Controller 202

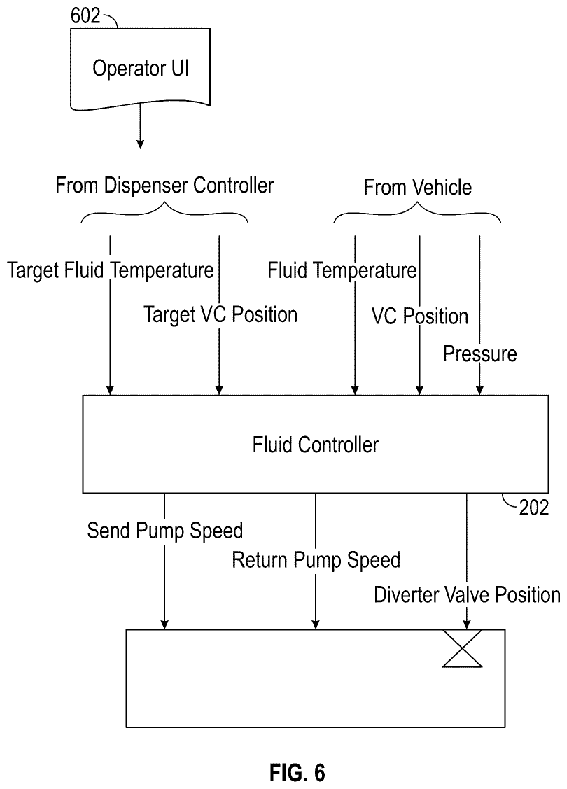

FIG. 6 is a block diagram illustrating the interaction between a fluid controller 202 and a thermal conditioning circuit 200 (e.g., including a dispenser 132) within the GSE 102 for a vehicle 208 (e.g., an electric aircraft), according to some examples. The diagram provides a detailed representation of the control logic and the flow of information necessary to manage the thermal conditioning of battery packs of the vehicle 208 during a charging process.

The fluid controller 202 serves as a decision-making component for the thermal conditioning circuit 200 and receives input signals from at least two sources: a dispenser controller 136 and the vehicle 208 itself.

From the dispenser controller 136, the fluid controller 202 receives target fluid temperature and target volume compensator (VC) position data. The target fluid temperature is a parameter that dictates the desired temperature of the coolant to be supplied to the aircraft's battery packs. The target VC position may indicate a desired position of a volume compensator within the aircraft, which adjusts to maintain a specific mass of coolant, accounting for temperature-induced volume changes. In some examples, the fluid controller 202 implements a Multi-Input Multi Output (MIMO) Internal Model Control (IMC) scheme that receives set points for coolant inlet temperature and VC fill target and tries to adjust the send and return pump speeds accordingly to achieve those set points.

From the vehicle 208, the fluid controller 202 receives feedback on the actual fluid temperature (T fluid temperature) and the VC position, as well as the pressure within the thermal conditioning circuit 200. This real-time data allows the fluid controller 202 to assess the current state of the thermal conditioning circuit and make necessary adjustments to achieve the target parameters.

Based on the inputs received, the fluid controller 202 outputs control signals to adjust the send pump speed (e.g., of the send pump 204) and the return pump speed (e.g., of the return pump 206), as well as the position of the diverter valve 222. The send pump speed determines the rate at which coolant is supplied to the aircraft, while the return pump speed controls the rate at which coolant is drawn away from the aircraft. A position of the diverter valve 222 dictates the path of the coolant flow—either directing it through a chiller 228 for cooling or through a heater 226 for heating, or a combination thereof to achieve a specific temperature.

As noted above, the return pump 206, which may be a positive displacement pump situated on the return flow path, may function as a variable valve. This configuration allows for precise control over the volume of coolant within the aircraft's thermal system. Working in concert with the send pump 204, a centrifugal pump responsible for delivering coolant to the aircraft, the return pump 206 enables the regulation of coolant volume on the aircraft. By adjusting the displacement volume of the return pump 206, the system can fine-tune the amount of coolant being drawn away from the aircraft, thereby maintaining a specific thermal condition within the battery packs.

The fluid controller 202, upon receiving inputs from various sensors and the dispenser controller 136, generates output control signals that adjust the operational speeds of both the send pump 204 and the return pump 206. The send pump speed is a parameter that influences the rate at which coolant is introduced into the aircraft's thermal system, directly affecting the rate of heat absorption from the battery packs. Conversely, the return pump speed, modulated by the variable valve functionality of the positive displacement pump, governs the rate at which coolant is extracted from the aircraft. This extraction rate assists in managing the thermal load and ensuring that the coolant retains its capacity to absorb heat on subsequent passes through the battery packs.

The diverter valve 222 is dynamically controlled by the fluid controller 202 to direct the coolant flow through the appropriate thermal management components. When positioned to channel coolant through the chiller 228, the diverter valve 222 facilitates the cooling mode, wherein the coolant is chilled to a predetermined first temperature, suitable for extracting excess heat from the battery packs. If the diverter valve 222 is adjusted to direct coolant through the heater 226, the thermal conditioning circuit 200 enters heating mode, raising the coolant temperature to a second, higher temperature, for warming the battery packs to a specified charging temperature. In scenarios where a specific coolant temperature is required that is neither the chilled nor the heated, the diverter valve 222 can be positioned to allow a proportional mix of coolant from both the chiller 228 and the heater 226, achieving a precise combined temperature appropriate for the thermal management needs of the moment.

The fluid controller 202 may receive and process temperature information from an array of sensors distributed throughout the thermal conditioning circuit 200. These sensors include, but are not limited to, temperature sensors located within both the send and return conduits, such as a coolant send temperature sensor and a coolant return conductor temperature sensor, which provide rapid feedback on the temperature of the coolant as it travels to and from the aircraft.

Additionally, the fluid controller 202 receives data from temperature sensors integrated within the connector 144, for example embedded in a charge handle, which monitor the temperature at this interface between the GSE 102 and a vehicle 208. Temperature sensors within the coolant reservoir contribute to the dataset by tracking the temperature of the stored coolant, ensuring that the chiller 228 and heater 226 are functioning as expected and that the coolant is within the desired temperature range before circulation.

Moreover, the fluid controller 202 interfaces with onboard temperature sensors that are part of the aircraft's thermal management system. These onboard sensors provide information regarding the internal temperature conditions of the battery packs, allowing the fluid controller 202 to make adjustments to the thermal conditioning circuit 200 in real time. By integrating temperature data from multiple points within the thermal conditioning circuit 200, including the send and return paths, the connector interface, the coolant reservoir, and the aircraft itself, the fluid controller 202 can maintain an overview of the thermal state of the entire charging ecosystem.

The fluid controller 202 utilizes this temperature data to modulate the send pump 204 and return pump 206 speeds, as well as to adjust the position of the diverter valve 222, ensuring that the coolant's temperature and pressure meet the battery packs' current thermal requirements. Further, there are logics inside the fluid controller 202 that prevent over- or under-pressure conditions to protect the battery system on the aircraft (e.g., VC and cold plates).

### Data Flow 700

FIG. 7 is a block diagram that provides a detailed view of a data flow 700 for the charging and thermal management systems (e.g., the charger 108 and thermal conditioning system 120) for battery packs of an electric vehicle, according to some examples.

Charging and thermal management algorithms 702 may be executed by the GSE 102 (e.g., by the site server 142) and used to control the charger 108 and the thermal conditioning system 120. The charging and thermal management algorithms 702 may, in some examples where the vehicle is an electric aircraft, balance considerations relating to (1) maintaining optimal battery temperatures for charging and (2) preparing the batteries for aircraft takeoff. This may involve a strategic algorithmic approach to determine an optimal switching time between warming the batteries for efficient charging and cooling them for operational (e.g., takeoff) readiness. The goal may be to minimize the total turnaround time, encompassing both the charging and thermal conditioning phases. This nuanced balance enhances the efficiency and performance of electric aircraft operations.

The charging and thermal management algorithms 702 may receive information from a battery model 704, which encapsulates the electrical and thermal characteristics of the battery packs of a vehicle 208, such as charge acceptance, heat generation rates, and thermal response to charging currents. A maximum charge current 706 input ensures that the charging strategy respects an upper limit of current that the battery can safely handle, which prevents thermal stress and prolongs battery life.

Observers and algorithms that feed into the charging and thermal management algorithms 702 include:
Battery state observer 708: This observer (or estimator) may use a number of models to estimate various battery state parameters or variables of vehicle batteries that are not directly measured.
   For example, the battery state observer 708 may use thermal models and empirical data to estimate battery temperature during charging. The thermal models may account for the heat generated internally by the battery cells and the heat exchanged with the surrounding environment. Further, in some examples, the GSE 102 may only measure cell tab temperatures, but it may be desirable to control the charging current based on the minimum cell temperature (which is not measured directly). Hence, a thermal model of the cell and the measurements of tab temperature may be used by the battery state observer 708 to estimate the temperature distribution throughout a cell.
   The battery state observer 708 may further estimate the battery's state of charge (SOC), providing insights into the remaining charge capacity and the rate at which the SOC changes during charging or discharging, which is vital for planning the charging duration and intensity.
   The battery state observer 708 may further estimate the internal resistance of the battery cells, which can impact the efficiency of the charging process. The charging and thermal management algorithms 702 may, in some examples, use a resistance estimation to identify an optimal (or near optimal) time to do a “cold shock” on a battery pack to reduce battery temperature for the takeoff of an electric aircraft. In order to determine the optimal time for cold shock, it may be desirable to perform predictive simulation forward, for which resistance estimates may be used.
Volume compensator observer 710: This observes whether the volume changes in the coolant due to thermal expansion or contraction. It ensures that the coolant volume within the aircraft's thermal system remains constant, preventing overfilling or underfilling that could affect thermal management performance.
Battery State of Health (SOH) algorithm 712: Evaluates the battery's overall condition, including its ability to hold charge and any degradation that may have occurred over time. This information may be used to adjust the charging strategy to match the battery's current health status.

The outputs generated by the charging and thermal management algorithms 702, informed by the data from the observers, are provided to the fluid controller 202 and may include:
Coolant temperature setpoint 714: Determines the ideal temperature of the coolant to be supplied to the battery packs, which may vary depending on the phase of the charging cycle and the thermal load from the batteries.
Target volume compensator (VC) position 716: Specifies the desired position of the volume compensator within the aircraft's thermal management system. This position is adjusted to maintain the optimal volume of coolant, accounting for thermal expansion or contraction due to temperature changes.

The fluid controller 202 then outputs various control values including for example:
Pump speeds 718: Specifies the operational speeds for the coolant pumps (e.g., the send pump 204 and the return pump 206), which are adjusted to control the flow rate and pressure of the coolant, ensuring efficient heat transfer and maintaining the desired thermal conditions.
Valve positions 720: Dictates the configuration of the system's valves, which can include the diverter valve 222 and other controllable valves within the thermal management system, to direct the coolant flow appropriately for heating, cooling, or maintaining the battery temperature.

### Method 800

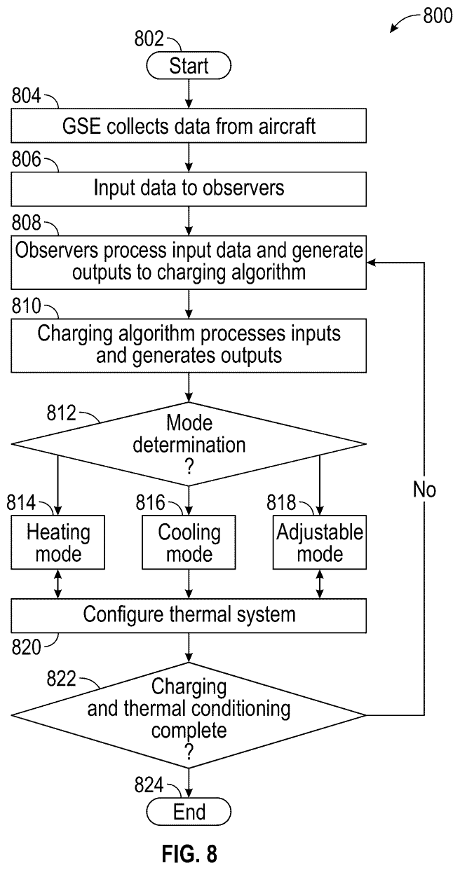

FIG. 8 is a flowchart illustrating a method 800 of data processing and mode determination operation within GSE 102 for electric vehicles (e.g., an aircraft), according to some examples.

The method 800 begins at the start block 802 and proceeds through a series of technical operations:

GSE Collects Data from Aircraft (Block 804): The GSE 102, which includes components such as the dispenser controller 136 and the fluid controller 202, initiates the process by collecting data from the aircraft. This data encompasses battery temperature, state of charge (SOC), state of health (SOH), and other relevant parameters that are crucial for determining the thermal management strategy.

Input Data to Observers (Block 806): The collected data is then input into a series of observers. These observers, such as the battery state observer 708 and the volume compensator observer 710 shown in FIG. 7, process the data to generate outputs that inform the charging and thermal management algorithms 702. The observers use technical models and empirical data to predict the battery's behavior during charging and to ensure that the coolant volume is maintained correctly within the aircraft's thermal system.

Observers Process Input Data and Generate Outputs to Charging Algorithm (Block 808): Each observer processes the input data according to its specific function. For example, the battery state observer 708 predicts temperature distribution within the battery cells, while the volume compensator observer 710 ensures the correct mass of coolant is maintained on the aircraft. The outputs from these observers are then fed into the charging and thermal management algorithms 702 to inform the subsequent operations of the thermal management process.

Charging Algorithm Processes Inputs and Generates Outputs (Block 810): The charging and thermal management algorithms 702, which may be executed by the dispenser controller 136, process the inputs from the observers. The algorithms 702 take into account the real-time state of the battery and the thermal requirements to generate a charging profile that includes the coolant temperature setpoint 714 and target volume compensator (VC) position 716. The charging profile is provided to the fluid controller 202, which then outputs pump speeds 718 and valve positions 720.

Mode Determination (Block 812): The thermal conditioning circuit 200 then determines the appropriate mode of operation based on the battery's thermal requirements and the target temperature parameters. The mode determination leads to one of three paths: heating mode, cooling mode, or adjustable mode.
Heating Mode (Block 814): If the battery temperature is below the desired range, the thermal conditioning circuit 200 enters heating mode. The diverter valve 222 is adjusted to direct the flow of coolant through the heater 226, which increases the temperature of the coolant before it is circulated through the battery packs.
Cooling Mode (Block 816): Conversely, if the battery temperature is above the desired range, the thermal conditioning circuit 200 enters cooling mode. The diverter valve 222 directs the coolant through the chiller 228, where it is cooled to the first temperature, typically around −10° C., before being sent to the aircraft.
Adjustable Mode (Block 818): If the battery requires a specific temperature that is not achieved by standard heating or cooling, the thermal conditioning circuit 200 enters adjustable mode. In this mode, the diverter valve 222 allows for a mixture of coolant from both the chiller 228 and the heater 226 to achieve the precise temperature requested by the aircraft.

Configure Thermal System (Block 820): Based on the selected mode, the thermal system is configured accordingly. This involves setting the diverter valve 222 to the correct position and adjusting the send (or feed) and return pump speeds to control the coolant flow rate.

Charging and Thermal Conditioning Complete? (Block 822): The system continuously monitors the charging and thermal conditioning process. If the battery reaches the target temperature and SOC, the process is deemed complete.

The method 800 concludes at the end block 824, indicating the end of the thermal management routine.

### Electric Vehicle Charging System 900

FIG. 9 is a schematic diagram illustrating the integration of selected components and systems within an electric vehicle charging system 900, according to some examples, segmented into three primary vertical systems: a charging station 914, a charging connector 916, and a vehicle 918. The diagram is organized to show the control and communication system, two isolated parallel charging circuits, and the thermal conditioning circuit 200, with each component described in relation to its position within these vertical systems.

### Control and Communication System

The control and communication system is an integrated network infrastructure that extends across the charging station 914, the charging connector 916, and the vehicle 918. This system ensures synchronized management and communication throughout the charging process, adhering to industry standards for electric aircraft charging.

Dispatch service 920 (charging station 914): Operates as the central command center for charging operations, orchestrating the charging schedules and actively interfacing with the charging station controller 922. It is responsible for the allocation of power resources, timing of charging cycles, and ensuring that the charging station's operations are synchronized with the flight schedules and energy requirements of the electric aircraft fleet. The dispatch service 920 utilizes algorithms to manage the logistics of electric aircraft charging, optimizing the use of infrastructure and minimizing wait times for charging.

Charging station controller 922 or dispenser controller 136 (charging station 914): As the central processing unit of the charging station 914, the charging station controller 922 is tasked with managing the activation of charging circuits and overseeing the thermal conditioning System 120 and dispenser 132. It ensures that the charging process is executed in accordance with the pre-configured settings, which may include parameters such as charging current limits, coolant temperature profiles, and data exchange protocols. The charging station controller 922 dynamically adjusts the charging parameters in real time based on feedback from the vehicle's battery management system and the thermal conditioning circuit, ensuring a safe, efficient, and rapid charging process.

Cloud data repository 924 (charging station 914): This repository serves as a data storage solution that aggregates and processes data generated during charging sessions. It supports the analysis and optimization of the charging process, providing insights into energy consumption patterns, charging efficiency, and vehicle health status. The cloud data repository 924 enables long-term data retention, trend analysis, and predictive maintenance, contributing to the continuous improvement of electric aircraft operations.

Data storage buffer 926 (charging station 914): The data storage buffer 926 acts as an intermediary storage point for data being transferred between the vehicle 918 and the cloud data repository 924. It ensures that large volumes of data, such as detailed flight logs, battery performance metrics, and maintenance records, are temporarily held and batch-processed for transmission over the network. This buffering mechanism is helpful for managing the high-throughput data exchange used by the charging system, including the secure offloading of flight data and the uploading of firmware updates.

Interlock circuit 928 (charging connector 916): The interlock circuit 928 is a safety mechanism that ensures a secure mechanical and electrical connection between the charging connector 916 and the vehicle 918. It prevents the flow of high-voltage current until a secure connection is verified, protecting personnel and equipment from potential electrical hazards. The interlock circuit 928 communicates with the charging station controller 922 to signal when it is safe to initiate the charging process, in compliance with the safety protocols outlined in industry standards.

1000BASE-T1 930 (charging connector 916): This connection supports the high-speed Ethernet-based communication protocol utilized within the charging system. The 1000BASE-T1 930 is designed for automotive and aviation applications, enabling robust and reliable data transmission over a single twisted-pair cable. It supports Power over Data Lines (PoDL), allowing for the simultaneous transmission of power and data, which simplifies the system architecture and reduces the complexity of onboard wiring. This protocol enables the real-time exchange of charging control commands, battery status information, and other data between the vehicle controller 932 and the charging station controller 922.

Vehicle controller 932 (vehicle 918): The vehicle controller 932 is the onboard intelligence of the vehicle 918, responsible for managing the charging process from the aircraft's perspective. It communicates with the charging station 914 to regulate the flow of power to the batteries, ensuring that the charging parameters are within the safe operating limits of the aircraft's battery management system. The vehicle controller 932 is designed to be compliant with industry standards, which includes the ability to handle ultra-fast charging, data offloading, and thermal management requirements.

Vehicle data storage 934 (vehicle 918): This onboard data repository captures and stores a comprehensive log of each charging session, including parameters such as the amount of energy transferred, charging duration, temperature profiles, and any anomalies detected during the process. The vehicle data storage 934 is instrumental in providing a historical record for each aircraft, which can be used for post-flight analysis, troubleshooting, and refining the vehicle's charging algorithms. It ensures that a detailed dataset is available for maintenance teams and engineers, aiding in the ongoing enhancement of charging practices and battery management strategies.

Thus, the control and communication system orchestrates the charging process through exchange of information between the vehicle 918 and the charging station 914. The vehicle controller 932 communicates the battery configuration and dynamic charging parameters, such as voltage targets and current limits, to the charging station controller 922. This allows for real-time adjustments to the charging rate based on the battery's thermal conditions and capacity to accept charge. Temperature sensors integrated into the charging connector 916 monitor the conditions of the charging conductors, enabling the charging station 914 (e.g., the fluid controller 150) to adjust the current limit dynamically to prevent overheating. Concurrently, an ethernet connection facilitates the secure offloading of flight data to the charging station 914, which is then stored in the cloud data repository 924 for maintenance and analysis purposes.

The charging station 914 responds to the vehicle's requests for coolant at specific temperatures, flow rates, and inlet pressures, supplying coolant directly from its reservoir or using a diverter valve to achieve the desired temperature.

### Isolated Parallel Charging Circuits

The isolated parallel charging circuits are components designed to deliver the necessary power to charge the vehicle's battery packs. These circuits are configured in two isolated channels to provide redundancy and enhance safety during the charging process. For example, the parallel charging circuits may be designed to accommodate the charging of multiple redundant battery packs in an electric aircraft. The electric vehicle charging system 900 is engineered to ensure that each battery pack can be charged independently and safely, leveraging multiple isolated charging circuits. To this end, the charging station 914 orchestrates the charging process and interfaces with the electric aircraft through a charging connector 916, which is designed to handle multiple charging channels.

The vehicle 918 may feature redundant battery packs, as a safety feature for electric aviation. Redundancy in battery packs means that the aircraft is equipped with multiple, isolated battery packs, providing backup power sources in case one fails or underperforms. This redundancy maintains power to critical systems in the event of a battery malfunction. To support the charging of these redundant battery packs, the electric vehicle charging system 900 includes multiple DC Power Supplies, specifically Channel 1 DC power supply 936 and Channel 2 DC power supply 938. Each power supply is connected to its respective battery pack via isolated charging channels, ensuring that the charging process for one battery pack does not interfere with or compromise the charging of another. Isolation monitors 940 and 942 are incorporated into each charging channel to continuously check for electrical isolation between the charging circuit and the aircraft's chassis. This is to prevent potential electrical hazards and to maintain the integrity of each isolated charging circuit.

The charging system is designed to allow charging channels 1 and 2 (or even more channels) to be paralleled within the vehicle for applications with single battery packs. This feature provides flexibility in the charging infrastructure, allowing the system to adapt to different battery configurations and to support aircraft with varying numbers of battery packs. Example components of the charging circuits include:

Channel 1 DC power supply 936 (charging station 914): This power supply unit is responsible for delivering direct current to the first isolated charging circuit. It is engineered to provide ultra-fast charging capabilities, ensuring that the electric aircraft's batteries can be charged in a minimal amount of time while maintaining the integrity and safety of the system.

Isolation monitor 940 (charging connector 916): The isolation monitor 940 is a safety device that ensures electrical isolation between the charging station 914 and the vehicle 918. It continuously monitors the electrical circuit to prevent any unintended conductive connections, thereby ensuring the safety of the charging process and compliance with the prescribed safety standards.

Charging channel 1 positive (HV1+) 984 and negative (HV1−) 944 (charging connector 916): These conductors are responsible for delivering the charging current to the vehicle's battery. The system is designed with parallel channels for applications involving multiple battery pack configurations, providing flexibility and adaptability to various electric aircraft charging requirements.

Conductor temperature sensors 912, 948, 986 and 988 (charging connector 916): These sensors are strategically placed to monitor the temperature of the charging conductors. By actively measuring the conductor temperatures, the system can prevent overheating and ensure safe charging conditions.

Channel 2 DC power supply 938 (charging station 914): Similar to Channel 1, this power supply provides direct current to the second isolated charging circuit. It operates in parallel with Channel 1 to enhance the charging efficiency and ensure a reliable power supply to the vehicle's batteries.

Isolation monitor 942 (charging connector 916): This device works in conjunction with the isolation monitor 940 to maintain electrical isolation between the charging station 914 and the vehicle 918. It is an additional layer of safety that ensures the charging process is free from electrical hazards.

Charging channel 2 positive (HV2+) 950 and negative (HV2−) 952 (charging connector 916): These conductors function similarly to those in channel 1, supplying the charging current to the vehicle's battery. They are designed to accommodate various electric aircraft configurations, providing a versatile solution for electric aircraft charging

Ground continuity monitor 956 (charging station 914): This monitor ensures that a proper ground connection is established and maintained via a chassis 992 throughout the charging process, verifying that the electrical grounding is adequate to protect against electrical faults.

### Thermal Conditioning Circuit 200

The thermal conditioning circuit 200 is a subsystem of the GSE 102 designed to regulate the temperature of the coolant used in controlling the battery packs' temperature during the charging process. This circuit is meticulously engineered to ensure battery health and charging efficiency, meeting the rigorous specifications of industry standards for electric aircraft charging systems.

Refrigerant loop 958 (charging station 914): The refrigerant loop 958 includes a reservoir 906, heat exchangers 960 and 994, pumps 962, and valves 964. This loop is responsible for the circulation and temperature regulation of the coolant, which directly impacts the thermal management of the aircraft's battery packs during charging.

Heat exchanger 960 (charging station 914): The heat exchanger 960 facilitates the transfer of heat between the coolant and the environment. It operates by allowing the coolant to absorb or dissipate heat, depending on the thermal requirements of the charging process. The heat exchanger 960 is constructed from materials with high thermal conductivity to ensure efficient heat transfer and is dimensioned to handle the thermal loads associated with rapid charging.

Pumps 962 (charging station 914): These pumps are responsible for circulating the coolant between the heat exchanger 960 and the reservoir 906. They are designed to provide a consistent flow and pressure, ensuring the coolant is delivered to the vehicle's battery packs at the correct temperature and flow rate.

Valve 964 (charging station 914): The valve 964 controls the flow of coolant between the heat exchanger 960 and the reservoir 906.

Reservoir 906 (charging station 914): Reservoir 906 serves as the storage unit for the coolant, which is conditioned to the precise temperature specifications required for the charging process. It is insulated to minimize thermal losses and is equipped with level sensors to monitor the quantity of coolant available, ensuring a sufficient supply of conditioned coolant is ready for use during the charging process.

Diverter valve 908 (charging station 914): The diverter valve 908 functions to regulate the direction of coolant flow, thereby controlling the temperature of the aircraft's battery packs during the charging cycle.

It incorporates an actuator system, which may be based on electrical, pneumatic, or hydraulic mechanisms, to adjust the valve's position with precision. This actuation is in direct response to control signals from the fluid controller 202 as part of the charging station controller 922. Position sensors integrated into the diverter valve 908 can provide real-time feedback on its status, ensuring that the control system can accurately maintain the desired coolant flow path.

In operation, the diverter valve 908 may support the various modes described herein, depending on the specific requirements of the thermal management system. For example, in a scenario where rapid cooling of the battery packs is needed, the diverter valve 908 may pull the coolant exclusively from the cooling system (e.g., from the reservoir 906). Conversely, if the ambient temperature is low and the battery packs require pre-heating, the diverter valve 908 may channel the coolant exclusively through the heater 966 to raise its temperature before it reaches the battery packs.

Where a more nuanced temperature control is required, the diverter valve 908 may be positioned to allow a mixture of coolant from both the reservoir 906/chiller and the heater 966, achieving a precise temperature that matches the thermal demands of the charging process. This mixed-mode operation exemplifies the valve's capability to provide a customized thermal response, enhancing the efficiency of the charging cycle and the operational longevity of the battery packs.

For example, in certain operational scenarios, the diverter valve 908 may operate to achieve a specific coolant temperature through the blending of different coolant flows. Consider a scenario where an electric aircraft's battery packs have been subjected to a series of charge cycles and are now at an elevated temperature. The aircraft is preparing for a subsequent charge cycle, and the battery packs may be brought to a precise temperature that optimizes charging efficiency and battery health. In this scenario, the charging station controller 922, having received information about the battery's current temperature, sends a command to the fluid controller 202 to initiate a temperature blending operation. The fluid controller 202 actuates the diverter valve 908 which is responsible for managing the flow of coolant that may already been warmed by its passage through the aircraft's battery packs.

The diverter valve 908 is capable of diverting all, none, or a portion of this return coolant flow—referred to as the diverted coolant flow—away from the return coolant flow and from flowing directly back into the reservoir 906. Instead, the diverted coolant flow is directed through the heater 966, where it may be further heated to a higher, predetermined temperature set by the thermal management system.

After the diverted coolant flow is heated by the heater 966, it is then blended or mixed into the send coolant flow. The send coolant flow comprises the initial send coolant from the reservoir 906 in addition to any heated, diverted coolant flow from the heater 966.

The diverter valve 908 thus enables precise control over the temperature of the send coolant flow by adjusting the amount of diverted coolant flow that is heated and subsequently mixed in. The proportion of the diverted coolant flow that is mixed with the initial send coolant flow from the reservoir 906 is modulated by the position of the diverter valve 908, which is tuned to achieve the desired temperature of the combined send coolant flow.

Temperature sensors 910 within the coolant send conduit 902 continuously monitor the temperature of the combined send coolant flow. If the sensors detect a temperature variance from the target, they signal the fluid controller 202, which then adjusts the actuation of the diverter valve 908 and/or the pump speeds of the send pump 970 and the return pump 968. The position of the diverter valve 908 may be modified to alter the ratio of the diverted coolant flow to the initial send coolant flow, thereby correcting the temperature of the combined send coolant flow.

The combined send coolant flow is circulated through the aircraft's battery packs, where it can effectively regulate the battery temperature, ensuring it remains within the optimal range for the upcoming charging cycle.

Heater 966 (charging station 914): The heater 966 is used when an increase in the temperature of the coolant is required. It features a high-capacity heating element capable of rapidly elevating the temperature of the coolant to the levels necessary for pre-heating the battery packs or maintaining them within the optimal temperature range. The heater 966 is controlled by the charging station controller 922, which modulates its output to provide precise temperature control.

Return pump 968 (charging station 914): The return pump 968 works in tandem with the send pump 970 to maintain a balanced and continuous flow of coolant through the thermal conditioning circuit 200. It draws the coolant away from the vehicle after it has absorbed heat from the battery packs, ensuring the system's thermal management efficiency.

Send pump 970 (charging station 914): The send pump 970 is responsible for propelling the conditioned coolant flow from the reservoir 906 and/or diverted coolant flow towards the vehicle's battery packs. It ensures the coolant is delivered at the correct pressure and flow rate to maintain the desired thermal conditions.

Filters 972 and 974 (charging station 914): These 972, 974 are placed within the coolant flow path to remove particulate matter and contaminants from the coolant. Filter 972 may be a coarse particulate filter, capturing larger particles, while filter 974 may be a fine particulate filter, removing finer debris. Together, they attend to the cleanliness and purity of the coolant for the protection and efficiency of the thermal management system.

Coolant send and return conduits 902 and 904 (charging connector 916): The coolant send and return conduits 902 and 904 are incorporated into the cable bundle 134 and are responsible for transporting the coolant between the charging station 914 and the vehicle 918. These conduits 902, 904 are constructed from materials that provide thermal insulation, ensuring minimal heat loss during coolant transport.

Temperature and pressure sensors 910, 976, and 978 (charging connector 916): These sensors are strategically placed to monitor the temperature and pressure of the coolant within the coolant return conduit 904 and coolant send conduit 902 of the connector 144. Coolant send temperature sensor 910 measures the temperature of the coolant, while coolant send pressure sensor 976 monitors the pressure of the coolant supply. Coolant return pressure sensor 978 measures the pressure of the coolant return, providing a view of the thermal management system's performance to the charging station controller 922. The data from these sensors is used by the charging station controller 922 for thermal management, enabling real-time adjustments to the coolant flow and temperature, maintaining battery efficiency and longevity.

Dry-break couplings 980 and 990 (charging connector 916): These couplings provide secure and leak-free connections for the charging connector 916 to corresponding charge ports 146 of the vehicles 918. They are designed to prevent coolant spillage and contamination during connection and disconnection, ensuring a clean and efficient thermal management process.

Coolant pump 982 (vehicle 918): The coolant pump 982 is an optional onboard component of the vehicle 918 that may be utilized to assist in the circulation of coolant through the vehicle 818 and it's battery I coolant passages 946 and battery 2 coolant passages 954. The coolant pump 982 can be activated to enhance the flow rate of the coolant, ensuring that the battery packs are maintained within temperature range for charging and operation.

### Example Vehicle Overview

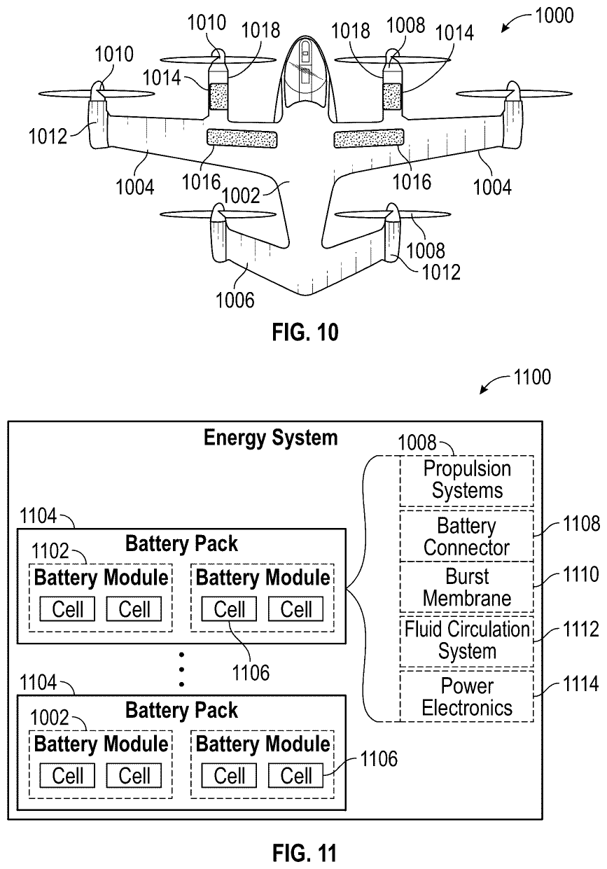

FIG. 10 is a plan view of a VTOL aircraft 1000 according to some examples. The aircraft 1000 includes a fuselage 1002, two wings 1004, an empennage 1006, and propulsion systems 1008 embodied as tiltable rotor assemblies 1010 located in nacelles 1012. The aircraft 1000 includes one or more nonlinear and isolated power sources in the example form of battery packs 1104 embodied in FIG. 10 as nacelle battery packs 1014 and wing battery packs 1016. In the illustrated example, the nacelle battery packs 1014 are located in inboard nacelles 1018, but it will be appreciated that the nacelle battery packs 1014 could be located in other nacelles 1012 forming part of the aircraft 1000. The aircraft 1000 will typically include associated equipment such as an electronic infrastructure, control surfaces, a cooling system, landing gear, and so forth.

The wings 1004 function to generate lift to support the aircraft 1000 during forward flight. The wings 1004 can additionally or alternately function to structurally support the battery packs 1104, battery module 1102, and/or propulsion systems 1008 under the influence of various structural stresses (e.g., aerodynamic forces, gravitational forces, propulsive forces, external point loads, distributed loads, and/or body forces, and so forth).

### Energy Storage System 1100

FIG. 11 is a schematic view of an aircraft energy storage system 1100 according to some examples. As shown, the energy storage system 1100 includes one or more battery packs 1104. Each battery pack 1104 may include one or more battery modules 1102, which in turn may comprise a number of cells 1106.

Typically associated with a battery pack 1104 are one or more propulsion systems 1008, a battery connector 1108 for connecting the battery pack 1104 to the energy storage system 1100, a burst membrane 1110 as part of a venting system, a fluid circulation system 1112 for cooling, and power electronics 1114 for regulating delivery of electrical power (from the battery during operation and to the battery during charging) and to provide integration of the battery pack 1104 with the electronic infrastructure of the energy storage system 1100. As discussed in more detail below, the propulsion systems 1008 may comprise multiple rotor assemblies.

The electronic infrastructure and the power electronics 1114 can additionally or alternately function to integrate the battery packs 1104 into the energy storage system 1100 of the aircraft. The electronic infrastructure can include a Battery Management System (BMS), power electronics (HV architecture, power components, and so forth), LV architecture (e.g., vehicle wire harness, data connections, and so forth), and/or any other suitable components. The electronic infrastructure can include inter-module electrical connections, which can transmit power and/or data between battery packs and/or modules. Inter-modules can include bulkhead connections, bus bars, wire harnessing, and/or any other suitable components.

The battery packs 1104 function to store electrochemical energy in a rechargeable manner for supply to the propulsion systems 1008. Battery packs 1104 can be arranged and/or distributed about the aircraft in any suitable manner. Battery packs 1104 can be arranged within wings (e.g., inside of an airfoil cavity), inside nacelles, and/or in any other suitable location on the aircraft. In a specific example, the energy storage system 1100 includes a first battery pack within an inboard portion of a left wing and a second battery pack within an inboard portion of a right wing. In a second specific example, the system includes a first battery pack within an inboard nacelle of a left wing and a second battery pack within an inboard nacelle of a right wing. Battery packs 1104 may include a plurality of battery modules 1102.

The energy storage system 1100 includes a cooling system (e.g., fluid circulation system 1112) that functions to circulate a working fluid within the battery pack 1104 to remove heat generated by the battery pack 1104 during operation or charging. Battery cells 1106, battery module 1102, and/or battery packs 1104 can be fluidly connected by the cooling system in series and/or parallel in any suitable manner.

### Computer System

FIG. 12 shows a diagrammatic representation of a machine 1200 in the example form of a computer system within which instructions 1202 (e.g., software, a program, an application, an applet, an app, or other executable code) for causing the machine 1200 to perform any one or more of the methodologies discussed herein may be executed. The machine 1200 may be any one or more of the controllers (e.g., the dispenser controller 136, fluid controller 150, charge controller 148, or monitoring and control center 154) discussed above.

The instructions 1202 may transform the general, non-programmed machine 1200 into a particular machine 1200 programmed to carry out the described and illustrated functions in the manner described. In some examples, the machine 1200 operates as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. Further, while only a single machine 1200 is illustrated, the term “machine” shall also be taken to include a collection of machines 1200 that individually or jointly execute the instructions 1202 to perform any one or more of the methodologies discussed herein.

The machine 1200 may include processors 1204, memory 1206, and I/O components 1208, which may be configured to communicate with each other such as via a bus 1210. In an example, the processors 1204 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1212 and a processor 1214 that may execute the instructions 1202. The term “processor” is intended to include multi-core processors that may comprise two or more independent processors (sometimes referred to as “cores”) that may execute instructions contemporaneously. Although FIG. 12 shows multiple processors 1204, the machine 1200 may include a single processor with a single core, a single processor with multiple cores (e.g., a multi-core processor), multiple processors with a single core, multiple processors with multiples cores, or any combination thereof.

The memory 1206 may include a main memory 1216, a static memory 1218, and a storage unit 1220, both accessible to the processors 1204 such as via the bus 1210. The main memory 1206, the static memory 1218, and storage unit 1220 store the instructions 1202 embodying any one or more of the methodologies or functions described herein. The instructions 1202 may also reside, completely or partially, within the main memory 1216, within the static memory 1218, within machine-readable medium 1222 within the storage unit 1220, within at least one of the processors 1204 (e.g., within the processor's cache memory), or any suitable combination thereof, during execution thereof by the machine 1200.

The I/O components 1208 may include a wide variety of components to receive input, provide output, produce output, transmit information, exchange information, capture measurements, and so on. The specific I/O components 1208 that are included in a particular machine will depend on the type of machine. For example, portable machines such as mobile phones will likely include a touch input device or other such input mechanisms, while a headless server machine will likely not include such a touch input device. It will be appreciated that the I/O components 1208 may include many other components that are not shown in FIG. 12. The I/O components 1208 are grouped according to functionality merely to simplify the following discussion and the grouping is in no way limiting. In various examples, the I/O components 1208 may include output components 1224 and input components 1226. The output components 1224 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1226 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 1208 may include biometric components 1228, motion components 1230, environmental components 1232, or position components 1234, among a wide array of other components. For example, the biometric components 1228 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1230 may include acceleration sensor components (e.g., accelerometer), gravitation sensor components, rotation sensor components (e.g., gyroscope), and so forth. The environmental components 1232 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1234 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1208 may include communication components 1236 operable to couple the machine 1200 to a network 1238 or devices 1240 via a coupling 1242 and a coupling 1244, respectively. For example, the communication components 1236 may include a network interface component or another suitable device to interface with the network 1238. In further examples, the communication components 1236 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1240 may be another machine or any of a wide variety of peripheral devices (e.g., a peripheral device coupled via a USB).

Moreover, the communication components 1236 may detect identifiers or include components operable to detect identifiers. For example, the communication components 1236 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1236, such as location via Internet Protocol (IP) geolocation, location via Wi-Fi® signal triangulation, location via detecting an NFC beacon signal that may indicate a particular location, and so forth.

### Executable Instructions And Machine Storage Medium

The various memories (i.e., memory 1206, main memory 1216, static memory 1218, and/or memory of the processors 1204) and/or storage unit 1220 may store data, such as a battery model, and one or more sets of instructions and data structures embodying or utilized by any one or more of the methodologies or functions described herein. These instructions and models (e.g., the instructions 1202), when executed by processors 1204, cause various operations to implement the disclosed examples, such as the various operations discussed above.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various examples, one or more portions of the network 1238 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1238 or a portion of the network 1238 may include a wireless or cellular network, and the coupling 1242 may be a Code Division Multiple Access (CDMA) connection, a Global System for Mobile communications (GSM) connection, or another type of cellular or wireless coupling. In this example, the coupling 1242 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1202 may be transmitted or received over the network 1238 using a transmission medium via a network interface device (e.g., a network interface component included in the communication components 1236) and utilizing any one of a number of well-known transfer protocols (e.g., hypertext transfer protocol (HTTP)). Similarly, the instructions 1202 may be transmitted or received using a transmission medium via the coupling 1244 (e.g., a peer-to-peer coupling) to the devices 1240. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1202 for execution by the machine 1200, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

### Conclusion

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number, respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

The various features, steps, operations, and processes described herein may be used independently of one another or may be combined in various ways. All possible combinations and sub-combinations are intended to fall within the scope of this disclosure. In addition, certain method or process blocks, or operations may be omitted in some implementations.

The term “operation” is used to refer to elements in the drawings of this disclosure for ease of reference and it will be appreciated that each “operation” may identify one or more operations, processes, actions, or steps, and may be performed by one or multiple components.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### Examples Set 1

In view of the disclosure above, various examples are set forth below. It should be noted that one or more features of an example, taken in isolation or combination, should be considered within the disclosure of this application.
Example 1 is a system for monitoring coolant composition, comprising: a reservoir containing a coolant mixture; a pressure measurement system configured to measure pressure at a bottom portion of the reservoir; a volume measurement system configured to measure volume of the coolant mixture in the reservoir; and a controller configured to: determine a density of the coolant mixture based on the pressure measurement and volume measurement; and calculate a composition of the coolant mixture based on the determined density.
In Example 2, the subject matter of Example 1, wherein the coolant mixture comprises glycol and water in a predetermined ratio optimized for thermal performance, wherein the ratio is selected to provide freeze protection while maximizing thermal conductivity.
In Example 3, the subject matter of any one or more of Examples 1-2, wherein the volume measurement system comprises at least one of: a level sensor positioned to measure coolant height; a flow meter positioned in a coolant line; or a volume compensator with a bellows position sensor.
In Example 4, the subject matter of any one or more of Examples 1-3, further comprising a conductivity sensor configured to validate the calculated composition by detecting sudden changes in conductivity that may indicate contamination.
In Example 5, the subject matter of any one or more of Examples 1-4, wherein the reservoir comprises: a pressurized headspace configured to maintain pressure between 25-29 kPa; and an air separation system configured to remove trapped air bubbles.
In Example 6, the subject matter of any one or more of Examples 1-5, wherein the controller is further configured to: compare the calculated composition to a predetermined range; and generate an alert based on the calculated composition deviating from the predetermined range.
In Example 7, the subject matter of any one or more of Examples 1-6, wherein the controller is configured to continuously monitor the composition during charging operations to maintain proper coolant mixture ratios.
Example 8 is a method for monitoring coolant composition, comprising: measuring pressure at a bottom portion of a reservoir containing a coolant mixture; measuring volume of the coolant mixture in the reservoir; determining a density of the coolant mixture based on the measured pressure and measured volume; and calculating a composition of the coolant mixture based on the determined density.
In Example 9, the subject matter of Example 8, further comprising: comparing the calculated composition to a predetermined range; and generating an alert if the calculated composition deviates from the predetermined range.
In Example 10, the subject matter of any one or more of Examples 8-9, wherein measuring volume comprises using at least one of: monitoring fluid level using a level sensor; measuring flow rates using flow meters; or tracking volume compensator position using a bellows sensor.
In Example 11, the subject matter of any one or more of Examples 8-10, further comprising: measuring electrical conductivity of the coolant mixture; and validating the calculated composition using the measured conductivity.
In Example 12, the subject matter of any one or more of Examples 8-11, further comprising maintaining reservoir pressure between 25-29 kPa using a pressurized headspace to prevent creating suction on an aircraft coolant system.
In Example 13, the subject matter of any one or more of Examples 8-12, further comprising removing air from the coolant mixture using an air separation system to optimize thermal conductivity.
In Example 14, the subject matter of any one or more of Examples 8-13, further comprising continuously monitoring the composition during charging operations to maintain proper coolant mixture ratios.
Example 15 is a ground support system for electric aircraft charging, comprising: a thermal management system including a coolant circuit; a composition monitoring system configured to: measure pressure and volume of coolant in the coolant circuit; determine coolant density based on the measured pressure and volume; and calculate coolant composition based on the determined density.
In Example 16, the subject matter of Example 15, wherein the thermal management system comprises: a reservoir with pressurized headspace; a temperature control system including a heater and chiller; and an air separation system configured to remove trapped bubbles.
In Example 17, the subject matter of any one or more of Examples 15-16, further comprising: a charging interface configured to connect to an aircraft; and a controller configured to regulate charging based on the calculated coolant composition.
In Example 18, the subject matter of any one or more of Examples 15-17, wherein the composition monitoring system is further configured to: validate the calculated composition using conductivity measurements; and generate alerts if the composition deviates from a predetermined range.
Example 19 is a thermal management system for an electric aircraft, comprising: a coolant reservoir containing a coolant mixture; a centrifugal send pump configured to direct coolant toward the aircraft; a positive displacement return pump configured to create variable flow resistance in a return path; and a controller configured to coordinate operation of both pumps to achieve volume control.
In Example 20, the subject matter of Example 19, further comprising: a pressure sensor positioned at a bottom of the reservoir; and a level sensor positioned to measure coolant height in the reservoir; wherein the controller determines coolant density based on pressure and height measurements.
In Example 21, the subject matter of any one or more of Examples 19-20, wherein the controller is configured to: operate the centrifugal send pump at a high flow rate; and adjust speed of the positive displacement return pump to regulate coolant volume.
In Example 22, the subject matter of any one or more of Examples 19-21, further comprising: flow sensors positioned in send and return lines; wherein the controller determines volume changes based on flow rate differences.
In Example 23, the subject matter of any one or more of Examples 19-22, further comprising: a volume compensator observer configured to estimate coolant volume when direct measurement is unavailable.
In Example 24, the subject matter of any one or more of Examples 19-23, wherein: the positive displacement return pump comprises a gear pump; and the gear pump provides a volume control response through speed modulation.
In Example 25, the subject matter of any one or more of Examples 19-24, further comprising: an air separation system configured to remove air bubbles from the coolant to optimize thermal conductivity.
Example 26 is a method for controlling coolant volume in an electric aircraft thermal management system, comprising: operating a centrifugal send pump to direct coolant toward the aircraft at a high flow rate; operating a positive displacement return pump to create variable flow resistance in a return path by adjusting speed of the positive displacement return pump; and coordinating operation of both pumps to achieve rapid volume control of coolant delivered to the aircraft.
In Example 27, the subject matter of Example 26, wherein: the positive displacement return pump comprises a gear pump; and adjusting the speed of the gear pump provides a volume control response through controlled mechanical displacement.
In Example 28, the subject matter of any one or more of Examples 26-27, further comprising: monitoring flow rates through sensors positioned in send and return lines; and determining coolant volume changes based on differences between the monitored flow rates.
In Example 29, the subject matter of any one or more of Examples 26-28, further comprising: receiving a volume-related feedback signal from a bellows position sensor on the aircraft; and adjusting speeds of the pumps based on the received feedback signal.
In Example 30, the subject matter of any one or more of Examples 26-29, further comprising: estimating current coolant volume using a volume compensator observer model when direct measurement becomes unavailable.
In Example 31, the subject matter of any one or more of Examples 26-30, further comprising: filtering coolant directed to the positive displacement return pump to protect internal gear components from particulate damage.
In Example 32, the subject matter of any one or more of Examples 26-31, further comprising: maintaining pump prime by pressurizing a reservoir headspace when the pumps are positioned below the aircraft.
Example 33 is a ground support system for electric aircraft, comprising: a coolant reservoir containing a coolant mixture; a pressure sensor positioned in the reservoir; a level sensor positioned to measure coolant height; and a controller configured to: determine coolant density based on pressure and height measurements; and calculate a glycol-to-water ratio based on the determined density.
In Example 34, the subject matter of Example 33, further comprising: a conductivity sensor configured to detect contamination of the coolant through monitoring of electrical conductivity.
In Example 35, the subject matter of any one or more of Examples 33-34, further comprising: an ion exchange cartridge configured to remove conductive elements from the coolant to prevent corrosion.
In Example 36, the subject matter of any one or more of Examples 33-35, wherein: the controller is configured to prevent charging operations if the calculated glycol-to-water ratio is outside a predetermined range optimized for thermal performance.

What is claimed is:

1. A system to monitor coolant composition, the system comprising:
a reservoir containing a coolant mixture;
a pressure measurement system configured to measure pressure at or near a bottom portion of the reservoir and generate a pressure measurement;
a volume measurement system configured to measure volume of the coolant mixture in the reservoir and generate a volume measurement; and
a controller configured to:
determine a density of the coolant mixture based on the pressure measurement and volume measurement; and
calculate a composition of the coolant mixture based on the determined density.

2. The system of claim 1, wherein the coolant mixture comprises glycol and water in a predetermined ratio optimized for thermal performance.

3. The system of claim 1, wherein the volume measurement system comprises at least one of:
a level sensor;
a flow meter; or
a volume compensator.

4. The system of claim 1, further comprising a conductivity sensor configured to validate the calculated composition.

5. The system of claim 1, wherein the reservoir comprises:
a pressurized headspace configured to maintain pressure between 25-29 kPa; and
an air separation system.

6. The system of claim 1, wherein the controller is further configured to:
compare the calculated composition to a predetermined range; and
generate an alert based on the calculated composition deviating from the predetermined range.

7. The system of claim 1, wherein the controller is configured to continuously monitor the composition during charging operations.

8. A method for monitoring coolant composition, comprising:
measuring pressure at a bottom portion of a reservoir containing a coolant mixture;
measuring volume of the coolant mixture in the reservoir;
determining a density of the coolant mixture based on the measured pressure and measured volume; and
calculating a composition of the coolant mixture based on the determined density.

9. The method of claim 8, further comprising:
comparing the calculated composition to a predetermined range; and
generating an alert if the calculated composition deviates from the predetermined range.

10. The method of claim 8, wherein measuring volume comprises using at least one of:
monitoring fluid level;
measuring flow rates; or tracking volume compensator position.

11. The method of claim 8, further comprising:
measuring electrical conductivity of the coolant mixture; and
validating the calculated composition using the measured conductivity.

12. The method of claim 8, further comprising maintaining reservoir pressure between 25-29 kPa using a pressurized headspace.

13. The method of claim 8, further comprising removing air from the coolant mixture using an air separation system.

14. The method of claim 8, further comprising continuously monitoring the composition during charging operations.

15. A ground support system for electric aircraft charging, comprising:
a thermal management system including a coolant circuit; and
a composition monitoring system configured to:
measure pressure and volume of coolant in the coolant circuit;
determine coolant density based on the measured pressure and volume; and
calculate coolant composition based on the determined density.

16. The ground support system of claim 15, wherein the thermal management system comprises:
a reservoir with pressurized headspace;
a temperature control system; and
an air separation system.

17. The ground support system of claim 15, further comprising:
a charging interface configured to connect to an aircraft; and
a controller configured to regulate charging based on the calculated coolant composition.

18. The ground support system of claim 15, wherein the composition monitoring system is further configured to:
validate the calculated composition using conductivity measurements; and
generate alerts based on the composition deviating from a predetermined range.

19. The ground support system of claim 15, further comprising:
a centrifugal send pump configured to direct coolant in the coolant circuit toward an electric aircraft;
a positive displacement return pump configured to create variable flow resistance in a return path of the coolant circuit; and
a controller configured to coordinate operation of the send pump and the positive displacement return pump to achieve volume control in the coolant circuit.

20. The ground support system of claim 19, wherein the controller is configured to:
operate the centrifugal send pump at a high flow rate; and
adjust speed of the positive displacement return pump to regulate coolant volume.
